(19) United States
(12) Patent Application Publication
(10) Pub. No.: US 2025/0368429 A1
(43) Pub. Date: Dec. 4, 2025

(54) MANWAY ADAPTER AND GATE VALVE INSTALLATION ON A TANK SIDE MANWAY

(71) Applicant: Square Robot, Inc., Marlborough, MA (US)

(72) Inventors: David Lamont, Boston, MA (US); Evan Kuritzkes, Newton, MA (US)

(73) Assignee: Square Robot, Inc., Marlborough, MA (US)

(21) Appl. No.: 19/223,611

(22) Filed: May 30, 2025

Related U.S. Application Data
(60) Provisional application No. 63/654,532, filed on May 31, 2024.

(51) Int. Cl. B65D 90/10

(52) U.S. Cl. CPC B65D 90/10

(57) ABSTRACT

A system for coupling a device to a tank's side manway includes a housing, rod, barrier, and actuator is described herein. The housing, with a first end attachable to a gate valve and a second end with an aperture, contains a chamber and a longitudinal axis. The rod, moving along the axis, creates a seal through the aperture. The barrier, which can expand and retract, has a central shaft with ends that engage the rod. It also features a canopy, support rib, and actuating support. The canopy extends from the shaft's first end to its outer edge, with the rib along it and the actuating support connecting the rib and shaft. The barrier can retract inside and extend outside the housing, moved by the actuator.

### CROSS-REFERENCE TO RELATED APPLICATION

This application claims the benefit of priority of U.S. Provisional Patent Application No. 63/654,532, filed May 31, 2024. The contents of this provisional application are incorporated herein by reference in its entirety.

### BACKGROUND

Tanks can store fluids or liquids, including flammable fluids such as petroleum products. The fluid can corrode portions of the tank that come into contact with the fluid. External surfaces of the tank can corrode due to water or other fluids under the floor of the tank, or water that leaked into the tank through, for example, a roof seal and sank below the hydrocarbon fluid due to its higher density. Corrosive elements in the hydrocarbon fluid can also contribute to corrosion. This corrosion can eventually cause the tank to leak. However, it can be challenging, resource intensive, and hazardous to determine the integrity of the tank to prevent leaks.

### SUMMARY

This disclosure is directed to facilitating installation of a gate valve, manway adapter, isolation valve, or the like on side manway of an aboveground storage tank. Beneficially, a manway adapter, gate valve, side launcher, or other equipment may be coupled to a side manway to facilitate in-service tank inspection without requiring the product inside the tank to be drained below the level of the side manway. Additionally, this disclosure permits the side manway lid to be removed for any reason (e.g., replacement/maintenance of the lid or side manway, installation of a mixer or other equipment, etc.) without requiring the fluid in the tank to be drained. For example, the devices, methods, and the like disclosed herein allow for a side manway to be temporarily sealed while remaining accessible from the outside (e.g., accessible for the installation of equipment to the manway or in order to install a side launching system comprising a manway adapter, a gate valve, and a launcher for launching an autonomous tank inspection vehicle into the tank via the side manway).

According to some embodiments, the systems, methods, and apparatuses disclosed herein augment and improve the launching and recovery of an autonomous tank inspection vehicle via a side shell manway of an aboveground storage tank.

In general, removing the lid of a side manway requires labor and time intensive tasks such as draining the fluid in the tank below the level of the side manway before the lid may be opened. In the context of inspecting a tank, opening a side manway presents numerous technical challenges such as draining the product in the tank, risking exposure to flammable vapors following the draining process, or encountering significant pressure caused by the volume of fluid behind the side manway if the tank is not drained. Due to the technical challenges of inspecting a tank containing a flammable fluid, tank inspections may be performed in an out-of-service tank rather than in an in-service tank. However, out-of-service inspection also entails hazardous steps and high resource consumption. For example, the tank is first emptied of its liquid content (e.g., via one or more drainpipes). A manway of the tank may be sealed by a lid or in use by a device, such as a product mixer. The lid of the manway is removed, and the atmosphere inside the tank is degassed and rendered safe to allow operators and tools to enter. The residual sediments on the floor are collected, removed from the tank, and safely disposed of. Human operators or inspection vehicles may then enter the confined space under harsh and hazardous conditions to perform tedious plate-by-plate floor/wall inspection. Once the inspection is complete, the manway lid is closed, and the tank is refilled with flammable fluid. These additional steps taken to inspect the tank are time consuming, resource intensive, and hazardous for both inspection personnel and equipment.

Due to the hazards, time, and resource cost of out-of-service inspection, in-service inspection (e.g., via an autonomous tank inspection vehicle) is generally advantageous. However, in-service inspection also presents technical challenges. Various aspects of this disclosure address and solve technical challenges associated with in-service tank inspection. For example, the systems, methods, apparatuses, etc. to couple a device to a side manway of a tank, disclosed herein, improve the speed at which in-service inspections may be performed, reduce hazards associated with the installation of in-service inspection equipment, and reduce the cost of in-service inspections, among other benefits. These benefits are achieved, for example, by the ability to access and temporarily seal a side manway and allow the lid to be removed without draining the product from the tank.

Equipment and tools used for in-service tank inspection may be deployed into the tank from a manway located on the roof of the tank. However, the roof of the tank has a weight limitation based on construction, material, and design of the roof. Moreover, navigating a full-scale autonomous tank inspection vehicle through the roof manway of the tank can be complex and entails a hazardous classification of class 1, division 1 (“C1D1”) because explosive or flammable gases, vapors, or liquids can exist under regular operating conditions. In contrast, the hazardous classification for entering through the side manway is labeled as class 1, division 2 (“C1D2”), because explosive or flammable gases, vapors, etc. are not likely to exist under regular operating conditions. By using the side manway to perform tank inspection, hazards can be mitigated and access to the roof may be minimized or circumvented. For example, operators may utilize a system to couple a device to a side manway and related equipment at ground level. In other words, the systems, equipment, manway adapters, inspection vehicles and the like may be installed and operated without requiring access to the roof of the tank and without requiring that the tank be drained of fluid.

In other embodiments, the aspects of this disclosure may be utilized to seal, install equipment to, and/or otherwise access the side manway for any reason (e.g., for removing the lid to install equipment such as a product mixer to the manway). Accordingly, aspects of this disclosure decrease cost, increase speed, and decrease hazards associated with tank operations. These benefits are achieved because the embodiments, methods, and the like discussed herein remove the need to drain the fluid in the tank below the level of the side manway before opening/interacting with the side manway, which in turn avoids the presence of hazardous vapors at the side manway. A vapor layer may reside on the surface of the flammable fluid.

In specific embodiments, aspects of this disclosure allow for a side launcher, manway adapter, and a gate valve for the launch and recovery of an autonomous tank inspection vehicle via a side shell manway of an aboveground storage tank to be readily installed or removed. The launcher can provide a pathway for safely inserting and retrieving an autonomous vehicle into and from a tank containing a flammable fluid. The tank can include a side entry using a manway located at the side of the tank. A gate valve may be temporarily or permanently embedded, attached, or connected to the manway of the tank via a manway adapter. The launcher may be temporarily or permanently embedded, attached, or connected to the gate valve. The systems, methods, and the like disclosed herein may assist and improve the process of embedding, attaching, or connecting the manway adapter, gate valve/isolation valve, and side launcher to the side manway.

Additionally, some side launching systems and/or side launchers are configured to connect to an opening that is 24″ in diameter, which would normally require hot tapping a 24″ diameter hole in the side manway lid. Tank owners are usually comfortable hot tapping up to 18″ diameter holes using traditional methods, and hot tapping a 24″ diameter hole presents increased risk that discourages the use of a side launching vehicle. Furthermore, hot tapping a 24″ hole may result in an opening that may not perfectly align with the side manway diameter, causing issues when launching and recovering a side launched inspection vehicle. For example, misalignment can result in damage (e.g., scratches, scrapes, etc.) to the vehicle or even block the vehicle due to the tight fit of the vehicle inside the side launcher. Aspects of this disclosure beneficially provide a technical solution to and avoid the hazards/challenges associated with hot tapping a 24″ diameter opening on a side manway when installing a device, such as a side launcher, without draining fluid from the tank. Specifically, the systems, methods, and the like disclosed herein allow for the installation of a device to a side manway that ultimately results in a full 24″ diameter opening but only requires hot tapping a hole that is smaller than 24″ in diameter (e.g., 18″ or less, 14″ or less, 12″ or less, etc.). In short, aspects of this disclosure reduce the required diameter when hot tapping a side manway while still allowing access to the entirety of the side manway 24″ opening without draining fluid below the level of the side manway.

At least one aspect is direct to a system to couple a device to a side manway of a tank including a fluid. The system can include a housing, a rod, a barrier, and an actuator. The housing can include a first end and a second end, and a chamber. The first end of the housing can be configured to couple to a gate valve. The second end of the housing can be configured to have an aperture. The chamber can be defined between the first end and the second end of the housing. The chamber can extend along a longitudinal axis. The rod can be within the aperture to create a seal between the chamber and an exterior of the housing. The rod can be configured to move along the longitudinal axis in either a first direction toward the first end of the housing or in a second direction toward the second end of the housing. The barrier can be configured to move between an expanded state and a retracted state. The barrier can be configured to be disposed inside the housing in the retracted state and can include: a central shaft, a canopy, a support rib, and an actuating support. The central shaft can have a first end and a second end. The second end can be configured to engage with the rod. The canopy can have a central edge coupled to the first end of the central shaft and can extend radially from the central shaft to an outer edge of the canopy. The support rib can extend radially along the canopy. The actuating support can have a first end and a second end. The first end can be coupled to the support rib and the second end can be slidably coupled to the central shaft. The actuator can be configured to move the second end of the actuating support between a first position relative to the central shaft and a second position closer to the first end of the central shaft so as to expand the canopy outward and in a radial direction away from the central shaft to the expanded state or contract the canopy inward and in the radial direction toward the central shaft to the retracted state.

The actuator can include a runner. The runner can be moveable toward the first end of the central shaft and the second end of the central shaft in response to a rotation of the rod while the rod is engaged with the central shaft. The rotation of the rod in a first direction, while engaged with the central shaft, can move the second end of the support rib toward the second position relative to the central shaft and thereby moves the canopy toward the expanded state. The rotation of the rod in a second direction opposite the first direction, while engaged with the central shaft, moves the second end of the support rib toward the first position relative to the central shaft and thereby moves the canopy toward the retracted state.

The central can include a hub disposed within the central shaft. The hub can have an open state and a closed state. The hub can be configured to secure the support rib in the second position and the canopy in the expanded state. The rod can be configured to toggle the hub between the open state or the closed state.

The actuator can include a piston. The piston can be configured to receive pressurized hydraulic fluid.

The canopy can include a fluid-facing surface, a tank-facing surface, and a sealing surface. The fluid-facing surface can be configured to face toward an interior of the tank when in the expanded state inside the tank. The tank-facing surface, which can be opposite the fluid-facing surface, can be configured to face toward the exterior of the tank when in the expanded state inside the tank. The sealing surface can be coupled to the tank-facing surface of the canopy proximate to the outer edge of the canopy. The sealing surface can be configured to engage a wall of the tank around the side manway to form a fluid-tight seal.

The system can include a first pressure sensor and a second pressure sensor. The first pressure sensor can be coupled to the system on a fluid-facing side of the canopy and configured to detect a first pressure. The second pressure sensor can be coupled to the system on a tank-facing side of the canopy and configured to detect a second pressure.

The sealing surface can extend continuously around a perimeter of the outer edge of the canopy.

The housing can include a value configured to seal or unseal the chamber. The valve can be configured to create a pressure differential across the canopy to secure the canopy in the expanded state against the tank in response to an unsealing of the chamber while the canopy is in the expanded state inside the tank.

At least one aspect is directed to a method to couple a device to a side manway of a tank comprising a fluid. The method can include providing a barrier that is engageable with a rod and moveable between an expanded state and a retracted state. The method can include disposing the barrier within a housing in the retracted state. The method can include coupling the housing to a gate valve of the tank such that the rod extends out of the housing via a seal and away from the tank. The method can include opening the gate valve to allow fluid to fill and pressurize the housing around the barrier in the retracted state. The method can include inserting, via a first movement of the rod, the barrier into the tank by moving the rod towards the tank. The method can include moving, via an actuator, the barrier from the retracted state to the expanded state while inside the tank and clear of the side manway. The method can include engaging, via a second movement of the rod opposite the first movement, the barrier with an inner wall of the tank around the side manway. The method can include depressurizing the housing to create a pressure differential across the barrier. The pressure differential can seal the barrier against the inner wall of the tank around the side manway. The method can include removing the rod, the housing, and the gate valve of the tank. The method can include installing the device to the side manway.

The method including depressurizing the housing can create the pressure differential across the barrier including opening a valve of the housing to expose an interior of the housing to ambient conditions.

The method can include coupling the housing to the device such that the rod extends out of the housing via the seal and away from the tank. The method can include engaging the rod with the barrier. The method can include moving, via the actuator, the barrier from the expanded state to the retracted state while inside the tank and clear of the side manway. The method can include moving, via a third movement of the rod opposite the first movement, the barrier in the retracted state from the tank through the device and into the housing. The method can include closing a valve of the device. The method can include removing the rod, the housing, and the barrier from the device.

The method can include pressurizing the housing prior to moving the barrier from the expanded state to the retracted state.

The method including pressurizing the housing prior to moving the barrier from the expanded state to the retracted state can include filling the housing with a pressurized tank fluid or an inert gas.

The method can include the device including an adapter configured to couple to a side launcher for an inspection vehicle. The method can include coupling the side launcher to the adapter.

At least one aspect is directed to a method to couple a device to a side manway of a tank comprising a fluid. The method can include providing a barrier that is engageable with a rod, moveable between an expanded state and a retracted state, and disposed within a housing in the retracted state. The method can include providing a controller communicatively connected to a sensor and an actuator associated with the barrier. The method can include coupling the housing to a gate valve of the tank such that the rod extends out of the housing via a seal and away from the tank. The method can include receiving, by controller, a first pressure value above a pressure threshold. The method can include, responsive to receiving the first pressure value, inserting the barrier into the tank by moving the rod towards the tank. The method can include receiving, by the controller, a first distance value indicating that the barrier is within the tank. The method can include, responsive to receiving the first distance value, sending a first signal by controller to the actuator to move the barrier from the retracted state to the expanded state. The method can include receiving, by the controller, a second distance value indicating that the barrier is engaging an inner wall of the tank around the side manway. The method can include, responsive to receiving the second distance value, opening a valve of the housing. The method can include receiving, by the controller, an indication of a pressure differential across the barrier above a pressure differential threshold. The method can include, responsive to receiving the indication of the pressure differential above the pressure threshold, removing the rod, the housing, and the gate valve of the tank. The method can include installing the device to the side manway.

The method can include the controller receiving the first pressure value via a pressure sensor within the housing.

The method can include the controller receiving the first distance value and the second distance value via a proximity sensor coupled to the barrier.

The method can include the controller receiving the indication of the pressure differential across the barrier based on a signal from a first pressure sensor on a fluid-facing side of the barrier and a signal from a second pressure sensor on a tank facing side of the barrier.

The method can include coupling the housing to the device such that the rod extends out of the housing via the seal and away from the tank. The method can include engaging the rod with the barrier. The method can include pressurizing the housing until controller detects at least one of: a third pressure within the housing above a second pressure threshold, or a second pressure differential across the barrier below a second pressure differential threshold. The method can include, responsive to receiving at least one of the third pressure within the housing above the second pressure threshold or the second pressure differential across the barrier below the second pressure differential threshold, sending a second signal by controller to the actuator to move the barrier from the expanded state to the retracted state. The method can include receiving, by the controller, a third distance value indicating that the barrier is within the housing. The method can include, responsive to receiving the third distance value, closing a valve of the device. The method can include removing the rod, the housing, and the barrier from the device.

The method can include the actuator being a piston configured to receive a hydraulic fluid and the controller is configured to vary a pressure of the hydraulic fluid within the piston.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example illustration of a tank containing a flammable fluid, in accordance with an implementation;

FIG. 2A is an example of a cross-sectional illustration of components of a system to couple a device to a side manway with a barrier of the system in a retracted state;

FIG. 2B is an example cross-sectional illustration of the components of the system to couple a device to a side manway with the barrier of the system in an expanded state;

FIG. 2C is a close-up view of the barrier of the system in the expanded state of FIG. 2B;

FIG. 3A-B show a flowchart illustrating example method steps for a method to couple a device to a side manway of a tank containing a fluid;

FIG. 4 is an example illustration of a tank side shell manway;

FIG. 5 is an example illustration of the tank side shell manway coupled to gate valve and a hot tap assembly;

FIG. 6 is an example illustration of cutting a coupon from the side shell manway;

FIG. 7 is an example illustration of the gate valve installed to the side manway;

FIG. 8 is an example illustration of the gate valve coupled to a system to install a device to the side manway of a tank;

FIG. 9 is an example illustration of a barrier of the system inserted into the tank, at pressure, with the barrier in a retracted state;

FIG. 10 is an example illustration of the barrier of the system inserted into the tank, at pressure, with the barrier in an extended state;

FIG. 11 is an example illustration of the barrier in the expanded state of FIG. 10 forming a temporary seal of the side manway while fluid is removed from the installer system;

FIG. 12 is an example illustration of the barrier of FIG. 11 left in the expanded state and forming a seal of the side manway while other components of the installer system are removed from the side manway;

FIG. 13 is an example illustration of the barrier in the extended acting as seal of the side manway while the side manway lid is removed;

FIG. 14 is an example illustration of installing a device, such as a manway adapter and isolation valve, to the side manway while the barrier seals the side manway in the expanded state;

FIG. 15 is an example illustration of coupling the installer system to the device to regain access to the barrier deployed in the expanded state;

FIG. 16 is an example illustration showing the barrier moved to the retracted state and returned to the installer system;

FIG. 17 is an example illustration of the side manway with equipment installed without requiring the fluid to be drained from the tank;

FIG. 18 is an example illustration of a side launcher attached to the side manway of FIG. 17, allowing a tank inspection vehicle to enter and inspect the tank via the side shell manway without requiring the fluid to be drained from the tank.

### DETAILED DESCRIPTION

Following below are more detailed descriptions of various concepts related to, and implementations of, systems, methods, and the like for installing a device to a tank side manway. These improved systems, methods, and apparatuses include launching and recovering an autonomous tank inspection vehicle via a side shell manway of an aboveground storage tank, utilizing the systems and methods disclosed herein to eliminate the need to lower the fluid level of the tank below the side manway. The various concepts introduced above and discussed in greater detail below may be implemented in any of a number of ways.

The systems, methods, apparatuses, etc. of this disclosure may allow for temporarily scaling a side manway of an aboveground storage tank in order to install equipment or remove the manway lid without draining fluid from a tank. For example, the systems and methods may be utilized in the process of installing and launching an autonomous tank inspection vehicle into the tank via the side manway. The technology disclosed may simplify the installation, launch, and recovery of an autonomous tank inspection vehicle via a side shell manway of an aboveground storage tank. The system can include a controller including one or more processors and memory to assess data from sensors of the system, access and enter a side manway, deploy a barrier, and thereby plug the side manway preventing flammable fluid from escaping upon opening of the manway lid.

The system can include a manway located at a side of the tank. The manway can be referred to as, and used interchangeably with other descriptive terms, such as side shell manway, side entry, or side door, for example. The system can allow for equipment (e.g., a manway adapter, a gate valve, a product mixer, etc.) to be installed on the side manway of the tank. The equipment may be installed without draining the fluid from the tank below the side manway.

Thus, systems, methods and apparatuses of this technical solution can allow for side entry for the autonomous vehicle to perform a tank inspection without emptying or draining a flammable fluid from the tank prior to inspecting the tank, thereby improving the efficiency and safety of the tank inspection process, saving time, and utilizing fewer resources. By performing the tank inspection via the side entry of the tank and without emptying the flammable fluid, the technology reduces hazardous steps to perform aboveground tank inspection and allows for more frequent tank inspections, which can facilitate early detection of tank failures, a more accurate prediction of when the tank may fail, and a forecast of the predicted tank integrity. For example, it may be more hazardous to perform a tank inspection from a top side of the tank because a tank inspection vehicle may be lifted via crane to the top side of the tank, which utilizes additional equipment and energy. Further, there is an increased risk of the equipment or personnel falling off a top side of the tank and getting injured or damaged, and there is also an increased risk if the structural integrity of the top side of the tank is weakened, thereby resulting in a potential collapse of the top side. Finally, an inspection vehicle may come into contact with increased flammable vapors that exist at the top side, relative to at the side shell manway.

### Exemplary Tank and Installation of Equipment on a Tank Side Manway

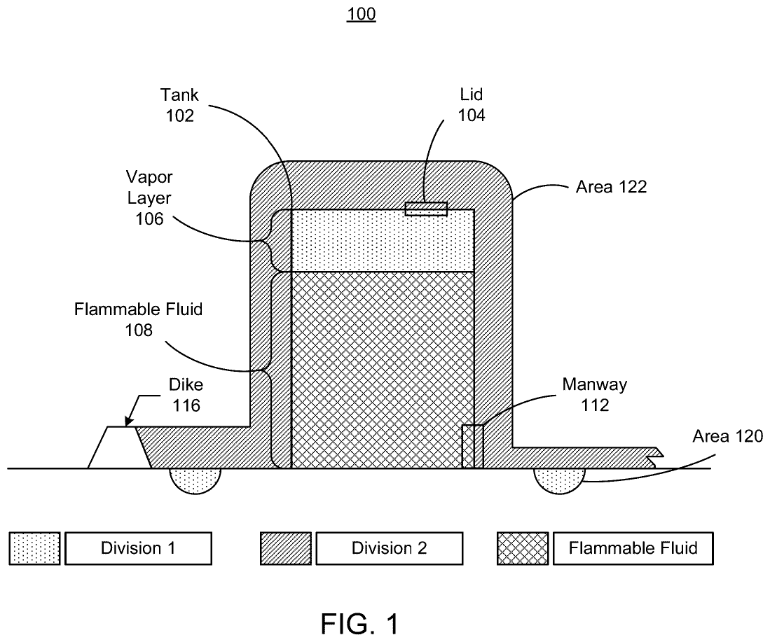

Referring to FIG. 1, example illustrations of a tank containing a flammable fluid, in accordance with some implementations, are shown. FIG. 1 provides a side view illustration of a tank 102. System 100 can include tank 102 configured for inspection of a vehicle and launcher, such as the vehicle, launcher, and the like disclosed and discussed in U.S. Patent Publication No. US 2023/0173551, which is incorporated by reference herein in its entirety. Tank 102 can include a lid 104, a vapor layer 106, a flammable fluid 108, a manway 112, and a dike 116. In some implementations, tank 102 can include a winch. Tank 102 can be constructed using one or more materials including metal (e.g., steel, aluminum, alloys, etc.), glass, or plastic (e.g., high-density polyethylene). Lid 104 of the tank can be constructed using one or more materials similar to tank 102. Lid 104 can be configured with a locking mechanism to prevent the opening of lid 104 prior to a completion of a tank inspection process. Lid 104 can be constructed to seal or keep vapor layer 106 within tank 102. Lid 104 can be disposed of on a top side (i.e., roof) of tank 102.

Within tank 102, and above the surface of flammable fluid 108, there can be vapor layer 106. Vapor layer 106 can refer to or include a gaseous state of flammable fluid 108. Vapor layer 106 can be internal to tank 102 and above flammable fluid 108. Vapor layer 106 may elevate based on the height of flammable fluid 108 (e.g., elevation of vapor layer 106 increases as the volume of flammable fluid 108 increases). Vapor layer 106 can be flammable.

Tank 102 can include manway 112 located at a side of tank 102. In a tank inspection process, a vehicle may access the interior of tank 102 via the side manway (e.g., manway 112). For example, manway 112 may be used for accessing the interior of tank 102 for other purposes or for installing other equipment to tank 102. Manway 112 may be included as part of the construction of tank 102. Manway 112 may include a lid. The lid may be similar to lid 104 on the top side of tank 102. The lid of the manway (e.g., manway 112) may be removed similarly to removing lid 104 on the roof of tank 102. Manway 112 may be located anywhere on the side of the tank. Manway 112 may be elevated from the ground (e.g., grade, tank floor, etc.), such as 12 inches, 14 inches, or 16 inches from the ground. Manway 112 may not be elevated from the ground (e.g., the bottom edge of manway 112 may sit on the ground).

Manway 112 of tank 102 may protrude from the tank shell. The tank shell can refer to the exterior surface of tank 102. Manway 112 may protrude from the tank shell to couple with a lid. For example, bolts may be used for coupling a lid with manway 112. The protrusion of manway 112 can prevent the bolts used from entering the interior of tank 102. In some implementations, manway 112 may not protrude from the tank shell. For example, manway 112 may be flushed or leveled to the tank shell (e.g., the exterior surface) of tank 102. Manway 112 can include a door or a gate to form an opening in the side of tank 102. The door or the gate of manway 112 can be opened via pulling, sliding, or lifting method.

System 100 can include dike 116 located around tank 102 to contain potential product leaks from tank 102. Dike 116 can be constructed with metal, cement, granite, etc. In some cases, the system 100 may not include dike 116.

Still referring to FIG. 1, areas around tank 102 may be classified with one or more hazardous classifications. As an example, the hazardous classification can include at least a class 1, division 1 (“C1D1”) and a class 1, division 2 (“C1D2”). The C1D1 hazardous classification can refer to an area where explosive or flammable gases, vapors, or liquids can exist under regular operating conditions. The C1D2 hazardous classification can refer to an area where explosive or flammable gases, vapors, or liquids are not likely to exist under regular operating conditions. For example, the area above flammable fluid 108 can include a hazardous classification of C1D1. This classification is due to the fumes and vapors rising up above flammable fluid 108 and vapor layer 106 of tank 102. The roof of tank 102 may be classified as C1D1. Subsequently after opening lid 104 on the roof of tank 102, an area 122 on the roof of tank 102 can be classified under C1D1 hazardous classification. In further examples, area 122 can be formed in the vicinity around tank 102. Area 122, referring to the surrounding of tank 102, can include a C1D2 hazardous classification, as with a location of manway 112. Accordingly, the location of manway 112 can entail less hazard than the location of lid 104 on the roof of tank 102.

A lid installed on manway 112 may be similar to the lid installed on a launcher for a tank inspection vehicle or lid 104 installed on the roof of tank 102. In some implementations, the lid installed on the side manway may be different than the lid installed on the launcher or lid 104 installed on the roof of tank 102 (e.g., different dimension and or bolt pattern).

As discussed above, without utilizing the systems, methods, and the like of the present disclosure, the first steps to installing the equipment to a side manway, such as manway 112 (e.g., a manway adapter, a gate valve, etc.) may require removing flammable fluid 108 from tank 102. The process of removing flammable fluid 108 from tank 102 may be hazardous, costly, and time intensive. Flammable fluid 108 may be reduced below the entrance formed by opening the lid of manway 112. For example, if manway 112 is elevated 12 inches from the tank floor, flammable fluid 108 may be reduced to a height of 11 inches or less within tank 102. The reduction of flammable fluid 108 below manway 112 can expose manway 112 to zone 0 areas. The zone 0 areas can refer to locations in which explosive or flammable gases or vapors are present continuously or for long periods of time or will frequently occur.

The lid of manway 112 may be removed subsequently to the removal of flammable fluid 108 below manway 112. However, without utilizing the systems and methods of the present disclosure, the fume or vapor from inside tank 102 may exit manway 112 once the lid is opened. In this instance, an area 120 around the side of tank 102 (e.g., the side where manway 112 is located) may be classified as a class 1, division 1 (“C1D1”) hazardous location, which is generally less advantageous and more dangerous to operate in compared to a C1D2 hazardous location, as illustrated by area 122.

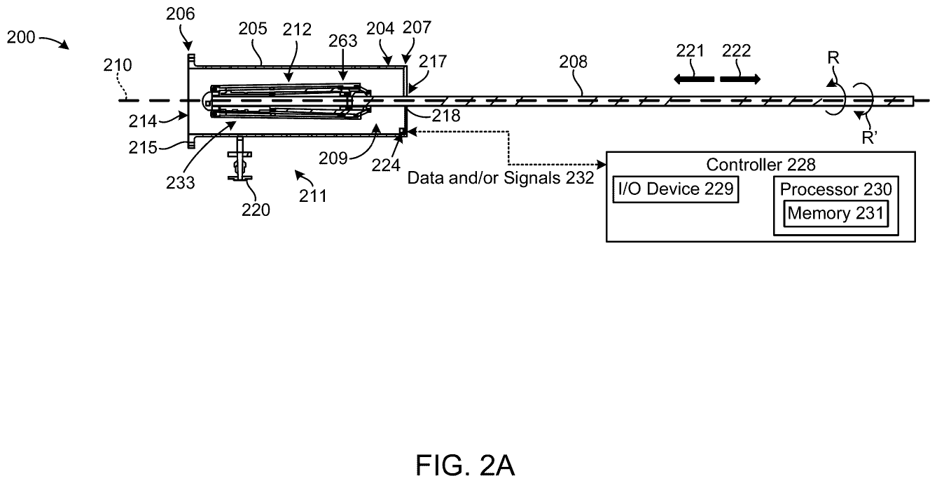

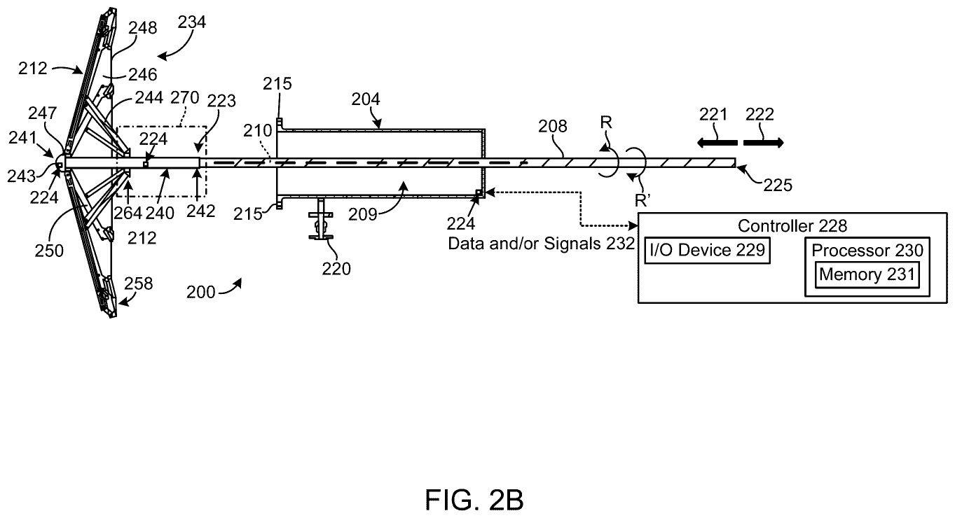

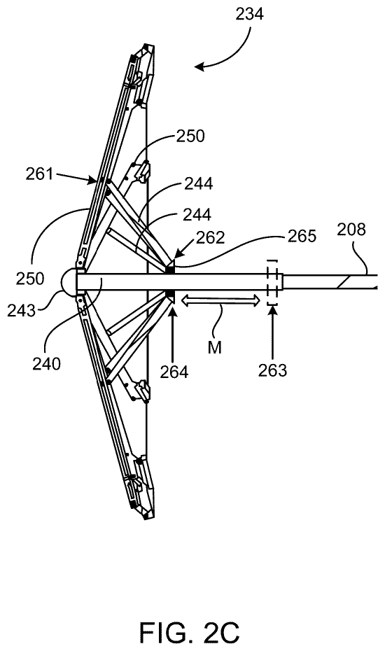

Referring to FIGS. 2A-B, illustrations of example components of a system 200 for equipment installation (e.g., a manway adapter, a gate valve, etc.) to a side manway of a tank are shown, according to an exemplary embodiment. Referring to FIG. 2A, an example system 200 for installing a device to a side manway (e.g., manway 112 of FIG. 1), in accordance with an implementation, is shown in a retracted state. System 200 can include a housing 204 configured to couple to the side manway (e.g., manway 112 of FIG. 1) in order to house the components of system 200. Specifically, housing 204 may enable the components of system 200 to access the side manway (e.g., manway 112 of FIG. 1) while under pressure (e.g., while fluid remains in tank 102) such that system 200 may temporarily seal manway 112 and allow for installation of equipment to manway 112. System 200 may also include a rod 208, a barrier 212, and an actuator 216. System 200 can also include a valve 220, one or more optional sensors 224, and/or an optional controller 228 to facilitate operation of system 200. System 200 can include hardware or a combination of hardware and software, such as communications buses, circuitry, processors, communications interfaces, sensors, actuators, fiber optic tethers, hydraulic connectors, drilling assemblies, pumps, fluid/gas purge systems, among others.

As mentioned above, housing 204 can include valve 220. Valve 220 can be configured to seal or unseal chamber 209. For example, valve 220 can be configured to create a pressure differential across canopy 246. The created pressure differential functions to secure canopy 246 in the expanded state against tank 102. In some cases, the securing of canopy 246 in the expanded state against tank 102 can be in response to an unsealing of chamber 209. For example, the unsealing of chamber 209 can occur while canopy 246 is in the expanded state inside tank 102. As described herein, “sealing” refers to a process that forms or results in a substantially leak-proof interface between two (or more) surfaces. For example, valve 220 can cause seal chamber 209 such that gases and/or fluids cannot or substantially cannot pass therethrough. In the example of valve 220, the pressure differential created across canopy 246 facilitates the blocking of fluids, gases, particles, or contaminants, or a combination thereof, from chamber 209. In some cases, the pressure differential can seal barrier 212 against an inner wall of tank 102 around a side of manway 112. As described herein, “unsealing” refers to an opposite process to that of sealing. For example, unsealing can create or restore fluid/gas communication passage from chamber 209.

Housing 204 may include an enclosure of a sufficient shape and size to receive barrier 212 (e.g., in a retracted state), at least a portion of rod 208, the one or more sensors 224, and/or other components of system 200. In some embodiments, housing 204 may have a cylindrical shape corresponding to the shape of a gate valve, the side manway (e.g., manway 112), or the like. In other embodiments, housing 204 may be rectangular, trapezoidal, octagonal, or another suitable shape. An outer wall 205 of housing 204 may be made of a suitable material such as metal (e.g., steel, aluminum, alloys, etc.), glass, plastic (e.g., high-density polyethylene), composite materials, or other materials capable of coupling to a gate valve and withstanding a pressure experienced by the fluid at the bottom of tank 102. In some embodiments, housing 204 has a first end 206 and a second end 207. First end 206 can be configured to couple to a gate valve. Second end 207 can have an aperture.

Housing 204 can include a chamber 209 defined between first end 206 and second end 207. In an example, housing 204 can include a chamber 209 defined between first end 206, second end 207, and outer wall 205. As shown in FIGS. 2A-B, chamber 209 may extend along a longitudinal axis 210 of housing 204. Chamber 209 can be defined along longitudinal axis 210 of housing 204 and may be located on an opposite side of outer wall 205 as an exterior 211 of housing 204 (e.g., chamber 209 may be an internal cavity defined inside housing 204).

First end 206 of housing 204 may include an aperture 214 and mounting features 215. First end 206 may be configured to couple to tank 102 or a component thereof as explained herein. For example, mounting features 215 may include a flange, a threaded aperture for bolts, clamps, fasteners, a surface for configured to receive a weld, or another suitable structure to enable first end 206 to be attached (e.g., temporarily coupled, coupled to form a fluid-tight seal, etc.) to tank 102, a gate valve of the side manway (e.g., manway 112), or the like. In this way, when first end 206 is coupled to tank 102, aperture 214 may receive a fluid from tank 102 in order to fill chamber 209 at a pressure (e.g., at a pressure caused by the depth of the fluid in tank 102 above the side manway (e.g., manway 112)). Further, barrier 212, rod 208, and/or other components of system 200 may move into and/or out of aperture 214 to enter tank 102, create a temporary seal of the side manway (e.g., manway 112), exit tank 102, or the like.

Second end 207 of housing 204 may be predominantly formed by outer wall 205. In some embodiments, second end 207 may include, comprise, and/or be formed by an end cap having one or more of sensors 224 coupled thereon, therein, thereto, etc. Second end 207 may also be coupled to one or more optional gas purge systems, purge valves, pressure gauges, or the like configured to pressurize chamber 209, insert a non-reactive fluid/gas into chamber 209, display a pressure within chamber 209, etc. Second end 207 may also include an aperture 217 configured to receive rod 208. For example, rod 208 disposed within aperture 217 to create a seal 218. Seal 218, for example, can be a seal between chamber 209 and an exterior of housing 204. In other words, seal 218 can prevent fluid within chamber 209 from escaping through aperture 217. Seal 218 may comprise a rubber O-ring, a flexible membrane configured to receive the rod, or another suitable interface to allow rod 208 to slide/move relative to housing 204 while chamber 209 is filled with pressurized fluid.

Further, aperture 217 may permit rod 208 to move at least in a first direction 221 (e.g., towards housing 204, towards tank 102, etc.) and/or in a second direction 222 (e.g., away from housing 204, away from tank 102, etc.). Additionally, aperture 217 may permit rod 208 to rotate (e.g., about longitudinal axis 210) in a first direction R or in a second direction R′ opposite the first direction R. As explained herein, movement/rotation of rod 208 may insert barrier 212 and/or other components of system 200 within tank 102, remove the same from tank 102, actuate actuator 216 to move the barrier to the expanded state, actuate actuator 216 to move barrier 212 (e.g., a second end of an actuating support) to the retracted state, cause rod 208 to couple to barrier 212, cause rod 208 to de-couple from barrier 212, or the like. Thus, by moving barrier 212, actuator 216 can be configured to expand canopy 246 outward along a radial direction away from the central shaft when in the expanded state. Conversely, actuator 216 can be configured to contract canopy 246 inward and in the radial direction toward the central shaft when in the retracted state.

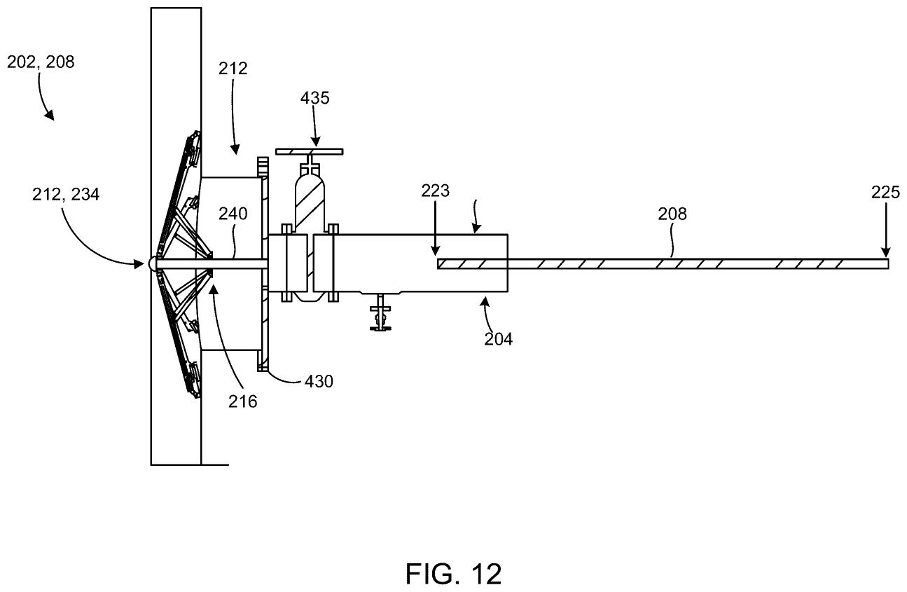

Rod 208 may include shaft having and/or extending between a first end 223 and a second end 225 (best shown in FIGS. 2B and 12). Like housing 204, rod 208 may be constructed of suitable materials to direct barrier 212 into/out of tank 102 while chamber 209 is under pressure (e.g., filled with flammable fluid). For example, rod 208 may be a solid, hollow, threaded, segmented, or other suitable shaft comprised of metal (e.g., steel, aluminum, alloys, etc.), glass, plastic (e.g., high-density polyethylene), composite materials, or other suitable materials. Rod 208 may have a generally cylindrical shape. For example, in some embodiments, rod 208 may have a diameter of 2 inches and a length from first end 223 to second end 225 of 12 feet. In some embodiments, the diameter of rod 208 may be up to 4 inches while the length may be up to 20 feet. The diameter and length may be larger or smaller than described above as needed and depending on the dimensions of tank 102, the side manway (e.g., manway 112), the device to be attached to the side manway (e.g., manway 112), etc.

First end 223 of rod 208 may be configured to engage with barrier 212, actuator 216, and/or other components of system 200 in order to position barrier 212 inside tank 102, inside chamber 209 of housing 204, etc. Further, in some embodiments, first end 223 of rod 208 may engage with actuator 216 to cause actuation of actuator 216 in order to move barrier 212 between the retracted state and the expanded state as discussed below. For example, barrier 212 can be moveable between the expanded state and the retracted state. As an illustration, first end 223 of rod 208 may be threaded, have a key-shaped bar configured to fit within a slot/crank of actuator 216, include a hydraulic line configured to provide hydraulic power/pressure to actuator 216, comprise a piston capable of actuating actuator 216, or any other suitable mechanism to engage, couple to, and/or activate/deactivate actuator 216. As a specific illustration, first end 223 may fit within a slot or gear system of actuator 216 such that rotation in the first direction R of rod 208, while engaged with a central shaft 240 of barrier 212 and/or actuator 216 moves the barrier towards the expanded state while rotation in the second direction R′ of rod 208, while engaged with central shaft 240 of barrier 212 and/or actuator 216 moves the barrier towards the retracted state.

In some examples, actuator 216 can be configured to move second end 262 of one (or more) of actuating supports 244 between a first position 263 relative to central shaft 240 and a second position 264. Second position 264 can be closer to first end 241 of central shaft 240 (as compared to first position 263). By being closer to first end 241 of central shaft 240, actuator 216 can be configured to expand canopy 246 outward and in a radial direction away from central shaft 240. This configuration is referred to in some examples as an “expanded state” or “extended state.” Canopy 246 can be contracted inward and in the radial direction toward central shaft 240, using actuator 216. This configuration is referred to in some examples as a “retracted state” or “contracted state.”

Canopy 246 can be contracted and/or extended via actuator 216. For example, through a series of mechanical actuators and tension cables, canopy 246 can be extended or contracted to a desired state. When the actuators are engaged, the cables can pull causing canopy 246 to contract and fold into a compact form. Conversely, when the actuators release, canopy 246 can extend and unfold.

Additionally, first end 223 of rod 208 may be releasably coupled to barrier 212 and/or actuator 216. For example, first end 223 may include a spring-loaded connector to couple/decouple rod 208 to barrier 212, a magnetic connector, a threaded connector, or the like such that rod 208 can be coupled to barrier 212 and/or decoupled from barrier 212 by an operator, by controller 228, etc. When coupled to barrier 212, actuator 216, and/or other components of system 200, rod 208 may permit movement of barrier 212, actuator 216, etc. (e.g., along longitudinal axis 210, into tank 102, out of tank 102, or the like) by translating movement of rod 208 to the other components. For example, an operator may grip a handle or the shaft of the rod and pull the rod in second direction 222 to move the attached barrier 212 in second direction 222.

Second end 225 of rod 208 may comprise a handle, a grip, one or more switches/power inputs/cranks, or the like. For example, in one embodiment, rod 208 may be a hollow cylinder with a rotating shaft disposed therein coupled to a crank at second end 225. Movement of the crank may cause rotation of the rotating shaft which may be translated to actuator 216 to cause movement of barrier 212. In another embodiment, a valve and/or hydraulic port may be activated at second end 225 or at another suitable location of rod 208 to transfer hydraulic power/pressure to actuator 216 (e.g., via a hydraulic line disposed within rod 208).

Barrier 212 is configured to toggle between a retracted state 233 (shown for example in FIGS. 2A, 8, 9, and 16) and an extended state 234 (shown for example in FIGS. 2B, 10, 11, 12, 13, 14, and 15). When in extended state 234, barrier 212 may form a temporary seal of the side manway (e.g., manway 112) to prevent fluid from leaving the side manway (e.g., manway 112) while a device, equipment, or the like is installed to the exterior of tank 102 (e.g., to the side manway (e.g., manway 112)). In some embodiments, barrier 212 may include a central shaft 240, a canopy 246, one or more support ribs 250, one or more actuating supports 244, and a sealing surface 258. As an example, in the expanded state, actuator 216 can move one or more of actuating supports 244 between a first position relative to central shaft 240 and a second position closer to the first end of central shaft 240 to enable canopy 246 to expand outward and in a radial direction away from central shaft 240. As an example, in the retracted state (also referred to interchangeably as the “contracted state”), actuator 216 can move one or more of actuating supports 244 between a first position relative to central shaft 240 and a second position closer to the first end of central shaft 240 to enable canopy 246 to contact inward and in the radial direction toward central shaft 240.

Central shaft 240 may form a central support of barrier 212, may house/couple to actuator 216, and/or may engage with rod 208. Central shaft 240 may include a first end 241 and a second end 242 with a solid and/or hollow shaft extending therebetween. Central shaft 240 may contain one or more compartments, openings, cavities, or the like to house actuator 216 and/or components thereof, to contain one or more sensors 224, to engage with rod 208, or the like. A hub 243 may be disposed at first end 241 which may act as an end cap for barrier 212, a pivot point for canopy 246 (e.g., a point around which canopy 246 extends), etc. Further, hub 243 may be coupled to and/or contain one or more sensors 224 (e.g., for measuring a pressure inside tank 102, for detecting a light level inside the tank, for detecting a temperature, etc.). Central shaft 240 may provide an anchoring point around which barrier 212 may expand and/or collapse (e.g., similar to an umbrella expanding and/or collapsing around its handle/central shaft).

Hub 243 can be disposed within central shaft 240. Hub 243 can have an open state and a closed state. Hub 243 can be configured to secure support rib 250 in second position 264 and canopy 246 in the expanded state. Rod 208 can be configured to toggle hub 243 between the open state and the closed state (e.g., such that hub 243 is either in the open state or the closed state). As described herein, toggling refers to a mechanism or control configured to switch a device/switch (e.g., hub 243) between different states (e.g., open state, closed state) in response to an actuation. Securing support rib 250 can include facilitating or causing hub 243 to lock rib 250 in place, ensuring it remains stable and fixed in the desired position. Hub 243, which can also be referred to as a latch mechanism, can prevent any unintended movement or collapse of canopy 246, maintaining the expanded state. By toggling hub 243 between the open and closed states, rod 208 can allow for easy adjustment and control of canopy 246's configuration.

Canopy 246 may comprise a flexible material configured to act as the primary structure forming the seal/plugging the side manway (e.g., manway 112) while barrier 212 is deployed inside tank 102 and covering the side manway (e.g., manway 112) in extended state 234. For example, canopy 246 may be composed of Kevlar fabric, Dyneema, Spectra, a carbon fiber weave/sheets, sheets of high strength composite materials, metal coated fabrics/meshes/weaves or the like. In other embodiments, canopy 246 may comprise high strength plates (e.g., steel plates, Kevlar plates, etc.) configured to telescopically extend outward to form a fluid-tight seal. For example, the plates may be configured to unfold, slide relative to one another, or the like and be coupled together with a flexible seal/binding or encased in a flexible outer skin. In still further embodiments, portions of canopy 246, barrier 212, and/or sealing surface 258 (as explained herein) may be inflatable or configured to swell/fill with a fluid.

Canopy 246 may be in a circular, umbrella-shaped, octagonal, square, or any other suitable shape when in extended state 234. For example, canopy 246 can include a central edge 247 coupled to first end 241 of central shaft 240 and extending radially from central shaft 240 to an outer edge 248 of canopy 246. Central edge 247 can include a central hole with its edges sealingly coupled (e.g., coupled in a manner that seals) to central shaft 240, hub 243, etc., and can extend radially outward to outer edge 248, with the material of canopy 246 extending and forming a fluid-proof membrane therebetween capable of withstanding high pressures/forces exerted against canopy 246 (e.g., pressures of the fluid in tank 102 acting on barrier 212). As described herein, a fluid-tight seal refers to a sealing interface configured to prevent passage of fluid.

As mentioned above, actuator 216 can be configured to move second end 262 of one (or more) of actuating supports 244 between first position 263 relative to central shaft 240 and second position 264. Actuator 216 can be configured to expand canopy 246 outward and in a radial direction away from central shaft 240 (e.g., expanded state). Actuator 216 can be configured to contract canopy 246 can be contracted inward and in the radial direction toward central shaft 240 (e.g., contracted state).

Sealing surface 258 may be a component of and/or may be coupled to canopy 246, support ribs 250, or another suitable component of barrier 212. In some examples, canopy 246 can include scaling surface 258 or another sealing surface similar to sealing surface 258. This sealing surface (e.g., sealing surface 258) can be coupled to the tank-facing surface of canopy 246 proximate outer edge 248 of canopy 246. Sealing surface 258 is configured to engage with, abut, or otherwise contact a wall of tank 102. For example, sealing surface 258 can be configured to engage with the wall of tank 102 around the side manway (e.g., manway 112) to form a fluid-tight seal (e.g., such that barrier 212 acts as an internal plug blocking fluid from leaving through the side manway while barrier 212 is in extended state 234). Sealing surface 258 may extend around the entire outer perimeter and/or outer edge 248 of canopy 246. For example, sealing surface 258 may include a rubber/elastomeric ring configured to form to and fit against tank 102 and/or a wall thereof. In other embodiments, sealing surface 258 may comprise an inflatable ring or the like disposed around barrier 212 and configured to fill with a fluid and/or pressurized gas such that scaling surface 258 may form a fluid-tight seal against the tank wall. Accordingly, hydraulic lines, fluid/gas lines, or the like may extend from the exterior of tank 102 (e.g., through rod 208) to scaling surface 258 (e.g., via support ribs 250, along canopy 246, etc.).

Support ribs 250 may extend radially along canopy 246. For example, support ribs 250 can extend from central shaft 240, hub 243, or the like to outer edge 248 of canopy 246 and/or to sealing surface 258. In this way, support ribs 250 may form a frame, scaffold, skeleton, and/or otherwise bolster/support canopy 246 and barrier 212 against forces and pressure while barrier 212 is in extended state 234 within tank 102. An end of each support rib 250 may be pivotably coupled to central shaft 240 and/or hub 243 to allow barrier 212 to expand radially outward or retract radially inward relative to longitudinal axis 210 and/or central shaft 240. Support ribs 250 may be composed of sufficient materials such as metals (e.g., steel, aluminum, alloys, etc.), high density plastics, composite materials, or other suitable materials.

Barrier 212 may also include one or more actuating supports 244. As best shown in FIG. 2C, actuating supports 244 may include a first end 261 coupled to, for example, one or more of support ribs 250 and a second end 262 slidably coupled to central shaft 240, coupled to actuator 216, or the like. In an example, one or more of actuating supports 244 can have a respective first end 261 coupled to one or more of support ribs 250 and second end 262 can be slidably coupled to central shaft 240. Actuating supports 244 may be made of materials similar or the same as support ribs 250. Actuating supports 244 may translate a movement of actuator 216 or a component thereof such that support ribs 250 extend and/or retract, thereby directing canopy 246 and barrier 212 towards extended state 234 and/or retracted state 233, respectively. As an example, in the expanded state, actuator 216 can move one or more of actuating supports 244 between a first position relative to central shaft 240 and a second position closer to the first end of central shaft 240 to enable canopy 246 to expand outward and in a radial direction away from central shaft 240. As an example, in the retracted state (also referred to interchangeably as the “contracted state”), actuator 216 can move one or more of actuating supports 244 between a first position relative to central shaft 240 and a second position closer to the first end of central shaft 240 to enable canopy 246 to contact inward and in the radial direction toward central shaft 240.

Actuating supports 244 may have one or both ends pivotably connected such that, as actuating support 244 moves, the angles with respect to actuating support 244 and the support rib 250 and/or central shaft 240 vary. In some embodiments, second end 262 of actuating support 244 is configured to alternate and/or move between a first position 263 (shown in FIG. 2A and corresponding to retracted state 233 of barrier 212) relative to central shaft 240 and a second position 264 (shown in FIGS. 2B and 2C and corresponding to extended state 234 of barrier 212) relative to central shaft 240. Specifically, second position 264 may be closer to first end 241 and/or hub 243 of central shaft 240 than first position 263. In this way, in an example embodiment, movement of actuator 216 may move second end 262 of actuating support 244 from first position 263 to second position 264 so as to expand canopy 246 outward and in a radial direction away from central shaft 240 to extended state 234. Alternatively, movement of actuator 216 may move second end 262 of actuating support 244 from second position 264 to first position 263 so as to retract (e.g., contract) the canopy inward and in the radial direction toward central shaft 240 to retracted state 233. In other words, movement of second end 262 of actuating support 244 (e.g., caused by actuation of actuator 216) as shown by and in the direction of arrow M in FIG. 2C may toggle barrier 212 between extended state 234 and retracted state 233.

Actuator 216 may be configured to move barrier 212 to and from retracted state 233 and/or extended state 234. Actuator 216 may be located at any suitable location of System 200. For example, as an illustration, actuator 216 is represented by a dashed box 270 in FIG. 2B. In such a configuration, actuator 216 may comprise a runner 265 that is moveable toward first end 241 of central shaft 240 and second end 242 of central shaft 240 (e.g., in response to rotation of rod 208 while rod 208 is engaged with central shaft 240). For example, first end 223 of rod 208 may couple, latch, and/or engage with the actuator or a component thereof (e.g., a threaded rod, a rack and pinion system, a gear/track system, etc.) configured to translate runner 265 between first position 263 and second position 264. In such an embodiment, actuating supports 244 may have their second ends coupled to runner 265 such that the movement of runner 265 translates from actuating supports 244 to support ribs 250 and to canopy 246 (e.g., to extend/retract canopy 246 and barrier 212). In other embodiments, actuator 216 may comprise a piston configured to actuate between first position 263 and second position 264, a piston/hydraulic circuit configured to receive pressurized hydraulic fluid to move actuating supports 244, or another suitable actuator 216.

Valve 220 may be coupled to housing 204 and/or integrally formed with housing 204. Valve 220 may be configured to open and close. When closed and when first end 206 of housing 204 is coupled to tank 102, housing 204 may be water-tight, air-tight, able to be pressurized, etc. When open, valve 220 may expose chamber 209 to ambient conditions/pressure. Further, when open, valve 220 may allow for fluid inside chamber 209 to drain (e.g., into a collection bin, into a conduit, via a pump, etc.).

Canopy 246 can include a fluid-facing surface configured to face toward an interior of tank 102. For example, when in the expanded state inside tank 102, the fluid-facing surface of canopy 246 can face toward an interior of tank 102. Canopy 246 can include a tank-facing surface opposite the fluid-facing surface. The tank-facing surface can be configured to face towards the exterior of tank 102 when in the expanded state inside tank 102. As described herein, to a first surface facing a second surface refers to the first surface being oriented such that its plane is substantially parallel to and directed toward the second surface (e.g., with respect to their normal vectors).

Sensors 224 are configured to collect data 232, display measurements, and/or communicate with controller 228. Sensors 224 may be placed at any suitable location in, on, adjacent to, etc., system 200. Sensors 224 can include one or more of a proximity sensor, touch sensor, accelerometer, angular rate sensor, gyroscope, speed sensor, torque sensor, pressure sensor, temperature sensor, light sensor, hydraulic flow sensor, electrical charge sensor, electrical current sensor, electrostatic sensor, position sensor, tilt sensor, etc. Sensors 224 can be connected to a power source such as a battery, an external generator, or the like. Sensors 224 can be attached to barrier 212 (e.g., on a fluid-facing surface of canopy 246 configured to face toward the interior of tank 102 when barrier 212 is in extended state 234 inside tank 102 and/or a tank-facing surface, opposite the fluid-facing surface, configured to face toward the exterior of tank 102 when barrier 212 is in extended state 234 inside tank 102) or embedded inside central shaft 240, hub 243, rod 208, housing 204, for example. Sensors 224 can collect information associated with system 200, components thereof, and/or tank 102. For example, sensors 224 may detect a position of actuator 216 (e.g., a location/distance of runner 265 along central shaft 240), a speed of the movement of rod 208, a pressure differential across barrier 212, a pressure differential between chamber 209 and exterior 211 of housing 204, a pressure inside chamber 209, a fluid amount/volume/level inside chamber 209 and/or tank 102, a component temperature, touch information of sealing surface 258 against the tank wall, an amount of inflation of an inflatable section (if any), and the like. Sensors 224 can provide data or measurements to controller 228, which can determine the state of system 200 (e.g., state of the system, component accelerations, angular rate, depth, position, etc.) and/or display information to an operator via the input/output device 229.

In some embodiments, sensors 224 can include a pressure switch activated by a pressure in chamber 209 reaching a pressure threshold. The pressure switch can be designed, constructed or configured to close an electrical contact when a certain set fluid pressure has been reached on its input. The pressure switch can be configured to make contact either on pressure rise or pressure fall. The pressure switch can detect mechanical force. The pressure switch can be configured with various types of sensing elements to detect or sense pressure. For example, the pressure switch can include a capsule, bellows, Bourdon tube, diaphragm or piston element that deforms or displaces proportionally to applied or detected pressure. The pressure sensing element of the pressure switch can be arranged to respond to a difference of two pressures. For example, a first pressure sensor coupled to system 200 on a fluid-facing side of canopy 246 can be configured to detect a first pressure, while a second pressure sensor coupled to system 200 on a tank-facing side of canopy 246 can be configured to detect a second pressure. In some examples, the difference with which the pressure sensing element of the pressure switch responds can be based on the difference between the first pressure and the second pressure. In some examples, a first pressure value indicating the first pressure can be received from the pressure switch of sensors 224, and a second pressure value indicating the second pressure can be received from the same or similar pressure switch of sensors 224. In some examples, controller 228 can receive the first pressure value indicating the first pressure and the second pressure value indicating the second pressure. In some cases, the pressure switch includes a pressure sensor. The resulting motion can be applied directly, or through amplifying levers, to a set of switch contacts that automatically move rod 208 and/or actuator 216 by closing an electronic circuit between controller 228 and the power source. The pressure switch can be configured to operate in a flammable fluid (e.g., inside chamber 209) by having an enclosure to prevent an arc at the contacts from igniting the surrounding fluid/gas. The switch enclosure can be formed of a material that can be non-flammable, weatherproof, corrosion resistant, or submersible.

The pressure switch can close an electrical contact to power a motor, actuator, or other assembly configured to move the rod (e.g., insert rod 208 and barrier 212 into tank 102 via manway 112) responsive to detecting a threshold pressure. The threshold pressure can correspond to chamber 209 reaching a pressure associated with the pressure of the fluid at the bottom of tank 102. The pressure switch can be designed, constructed, or operational to activate based on a depth and known density of the fluid. The pressure can be determined based on P=height*density*acceleration of gravity. The threshold pressure can be set based on determining the height of the fluid above the side manway (e.g., manway 112). The pressure switch can be configured to power on controller 228 responsive to detection of the threshold pressure.

Sensors 224 of system 200 can include a fuel level sensor. In some cases, system 200 can derive or determine the fuel level via an external fuel level sensor or by not using a separate fuel level sensor. For example, system 200 can derive the fuel level based on a depth and altitude of barrier 212 above the floor. In this way, barrier 212 may be able to navigate or locate its position relative to a side manway at a specific height on tank 102 (e.g., determine that a bottom edge of sealing surface 258 is sufficiently below the side manway (e.g., manway 112) to form a seal, a top edge of sealing surface 258 is sufficiently above the side manway (e.g., manway 112) to form a seal, etc.). In another example, system 200 can receive fuel level information from an external source (e.g., checking the mechanical level gauges installed in or on a tank) prior to deployment into the tank the mechanical level gauges usually installed in tanks.

The information identified by sensor(s) 224 can be stored in memory 231 of controller 228. The sensor(s) 224 can perform an operation by controller 228. The operation can include sensor selection, sensor initiation, or sensor deactivation. The sensor selection can select a sensor 224 from multiple sensors based on one or more commands to be executed by controller 228 (e.g., via the input output device “I/O Device” 229). The sensor initiation can activate at least one sensor 224 (e.g., a light and camera, a sonar device, etc.) to perform one or more commands, and the sensor deactivation can deactivate at least one sensor 224 upon completing the one or more commands. For example, sensor initiation and deactivation can include activating the camera and light to navigate within the tank and position barrier 212 and sealing surface 258 around/adjacent to the side manway (e.g., manway 112) and/or the tank wall, activating the sensor 224 to obtain proximity data of the tank (e.g., via a sonar sensor), and deactivating the sensor 224 upon plugging the side manway (e.g., manway 112) of tank 102, indicating completion of the one or more commands.

System 200 can use one or more sensors 224 to identify the location of the manway relative to barrier 212. For example, system 200 can utilize a light source and an imaging sensor (e.g., a camera) installed on barrier 212, canopy 246, support rib 250, central shaft 240, etc. System 200 and an operator can utilize the light and imaging sensor to verify the integrity of the seal formed by barrier 212 (e.g., determine whether fluid is leaking/flowing across the barrier, between sealing surface 258 and the tank wall, etc.).

Controller 228 is configured to receive communications from and/or send communications to other components of System 200. For example, controller 228 may receive signals from sensors 224 and provide a signal to the I/O device 229 indicative of data from sensors 224. In some embodiments, controller 228 may send one or more commands to a component of System 200. For example, controller 228 may send a command causing actuator 216 to activate, valve 220 to open/close, rod 208 to rotate/translate, or the like. Controller 228 may include a processor 230 and a memory 231 having instructions thereon that, when executed by processor 230, cause controller 228 to perform and/or assist with one or more steps of a method of installing a device to a tank side manway 112.

Operation of system 200 and the components thereof may include and be implemented using hardware or a combination of software and hardware. For example, in some embodiments, system 200 may include only hardware (e.g., may be manually operated, may be operated by an operator without assistance from controller 228 (if present)). In other embodiments, system 200 may include hardware and software such as one or more programs of controller 228 to receive/interpret/display a value from sensors 224, to automate, actuate, electronically cause movement of a component of system 200 (e.g., to activate a drilling assembly, to cause actuation of barrier 212 via electronic circuitry, hydraulic lines, pistons, etc., or the like). Each component of system 200 may, in some embodiments, include logical circuitry such as processor 230 (e.g., a central processing unit or CPU) that responds to, and processes one or more instructions fetched from memory 231 (e.g., a storage device, resource repository, etc.). One or more components of system 200 can include or use a microprocessor or a multi-core processor. A multi-core processor can include two or more processing units on a single computing component. Each component and/or operation of system 200 can be based on any of these processors, or any other processor capable of operating as described herein. Each processor can utilize instruction level parallelism, thread level parallelism, different levels of cache, etc. For example, system 200 can include at least one logic device such as a computing device (e.g., a laptop as controller 228) or server having at least one processor.

Controller 228 (or the other components of system 200) can initiate stop commands, initiate motion commands, and transmit or receive timing data, sensor data (e.g., pressure measurements, pressure differential measurements, etc.), or the like. One or more components can work individually when/if those components are external to system 200. As another example, a power source may be coupled to the components and include batteries, hydraulic lines, compressors, gas generators, and the like to generate, communicate, or otherwise provide power to, system 200 and components thereof. The components of system 200 can be connected or communicatively coupled to one another. The connection between the various components of system 200 can be mechanical/structural (e.g., physical coupling, welds, temporary couplings, etc.) and/or communicative (e.g., wired or wireless connections), or any combination thereof.

Controller 228 can determine (e.g., using a diagnostic program in memory 231), a malfunction of one or more components of system 200, which can be based on a signal received from the components or a discontinued electrical signal or hydraulic flow to the components. Controller 228 can further determine to use a different component, based on the malfunctioned components, to continue operation of system 200 to plug/seal the side manway (e.g., manway 112). For example, controller 228 can determine that barrier 212 has not formed a sufficient seal of the side manway (e.g., manway 112) due to the fluid ejecting into chamber 209, a pressure reading in chamber 209 exceeding a pressure threshold, or the like. Controller 228 may continue to actuate barrier 212 and maneuver barrier 212 against the tank wall until a seal is formed.

I/O device 229 can include an LCD display, which can include haptic feedback capability for receiving and transmitting information to controller 228. The LCD display can include a graphical user interface which can be used to configure system 200 settings prior to sealing the side manway or moving barrier 212 into the flammable fluid. In other embodiments, one or more components of the I/O device 229 may be separate from and communicatively coupled to system 200. For example, the I/O device 229 may include a personal computer, a laptop, a mobile device, a remote, and the like in communication with system 200, actuator 216, controller 228, the sensor(s) 224, etc. The I/O device 229 can maintain or update processes of system 200, controller 228, sensor(s) 224, actuator 216, etc. based on the received or transmitted information. The I/O device 229 can include one or more ports for external connection to system 200, such as a serial port, USB port, display port, Ethernet port, or Bluetooth receiver and transmitter. The one or more ports can be used to transfer one or more data to or from memory 231, such as an actuator control program, sensor data, or the like.

One or more components of system 200 such as barrier 212, canopy 246, etc. can be coated with non-flammable solution or an insulator. The non-flammable solution or insulator can be applied by spray coating, paint coating, attachment, or sheet cover. The non-flammable solution can include glass, mineral wool, gypsum, or magnesium. The insulator can include glass fiber, polyurethane, clay, or ethylene propylene diene terpolymer (“EPDM”) rubber. The one or more components can be coated with linked or merged non-flammable solution and insulator to form a protected layer. The non-flammable solution and insulator can be selected based on the flammable fluid contained inside the tank. The one or more components can incorporate the protected layer for flammable environment, for example, hub 243, actuator 216 (or a component thereof), and the like can be submerged in the tank containing a flammable fluid. The one or more components can be further coated with a water resistance solution including durable water repellent (“DWR”). The components coated with DWR can be hydrophobic, which can prevent fluid from entering housing 204. The one or more coating of housing 204, barrier 212, rod 208, or the like can be coated on the exterior of the components or embedded into the components.

System 200 and barrier 212 can operate under a mild environment, for example, below freezing temperature or above boiling temperature. Barrier 212 and other components of system 200 can operate under a submerged environment and may navigate in an in-service tank and form a seal around a side manway by inserting barrier 212 into the flammable fluid of tank 102 at pressure (e.g., maintaining the pressure present at the bottom of the tank, operating under the pressure of the fluid inside the tank without requiring draining of the fluid, etc.) In some cases, system 200 may not be coated with a non-flammable solution or insulator and perform an in-service tank inspection.

System 200 can be constructed to prevent sparks or electrostatic discharge. System 200 and components thereof can be constructed with one or more insulated layers to prevent sparks or electrostatic discharge. The one or more insulated layers can include a spark protection layer, which can be, for example, a rubber layer between one or more layers of steel, preventing accidental collision between the steel layers which can cause a spark. System 200 can be equipped with a non-sparking tool or at least one anti-static tool. The non-sparking tool can be characterized by lack of ferrous metals including steel or iron, which can prevent ignition of sparks under certain conditions. Barrier 212, housing 204, rod 208 or the like can be grounded by the anti-static tool, which can prevent static electricity build up to cause an ignition of any spilled fluids or vapors.

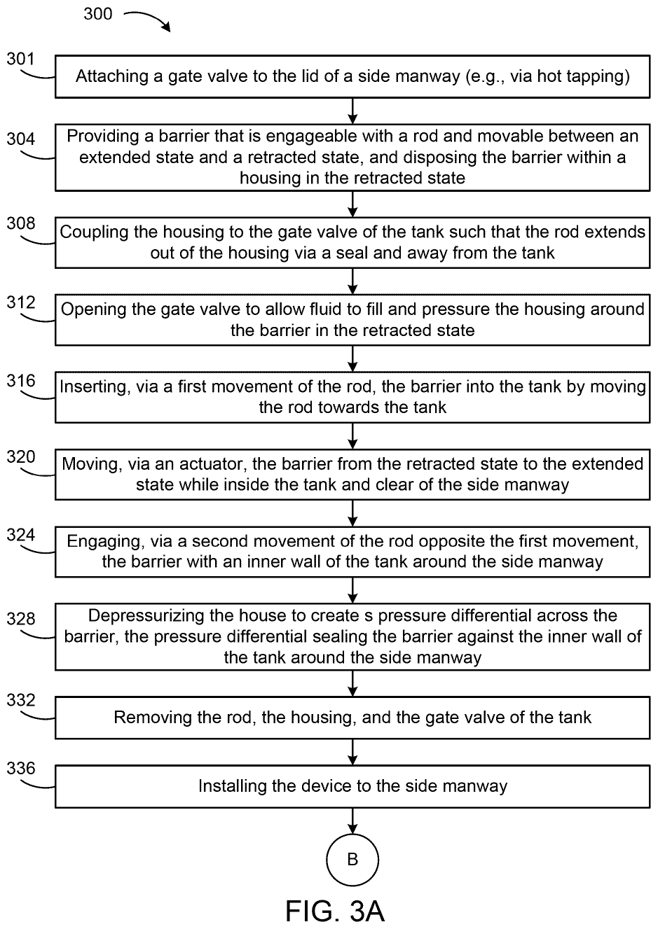

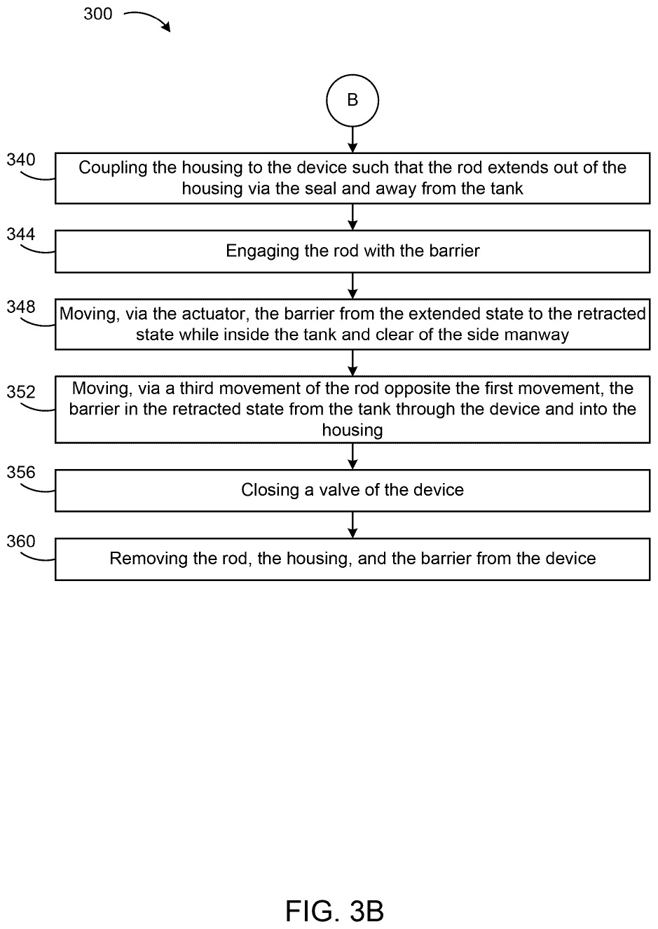

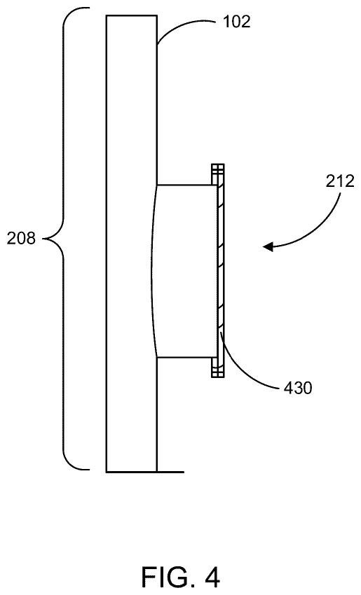

Turning to FIGS. 3A-B, example steps of a method 300 of plugging a side manway 112 for installation of a launcher and gate valve are shown, according to an illustrative embodiment. Referring to FIGS. 4-17, illustrations of the exemplary steps for method 300 of plugging the side manway (e.g., manway 112) for installation of a launcher and gate valve are shown and will be discussed in conjunction with the method steps below. In some embodiments, additional steps may be included, steps may be omitted, steps may be repeated, performed out of order, combined, or the like.

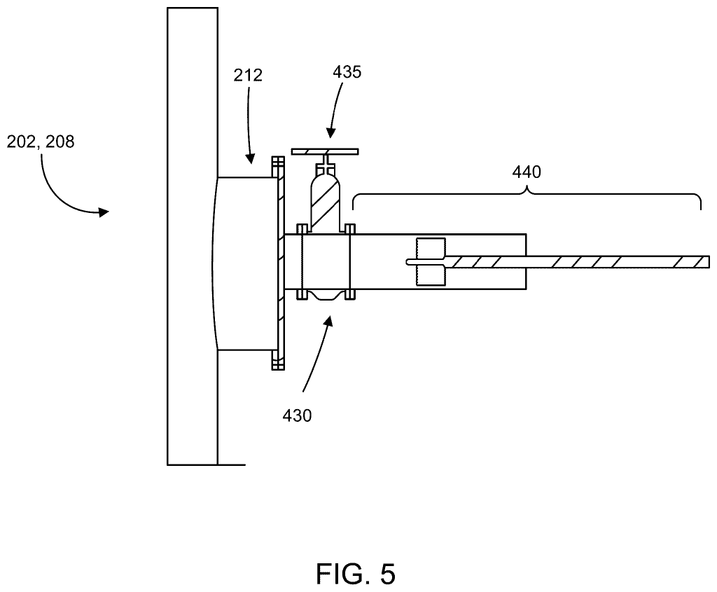

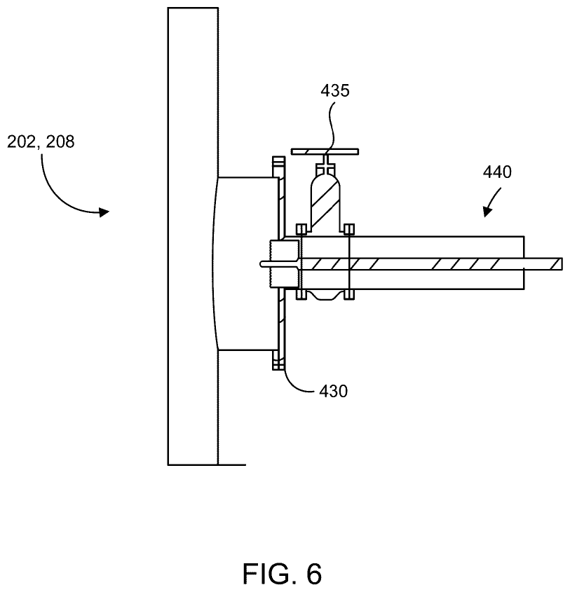

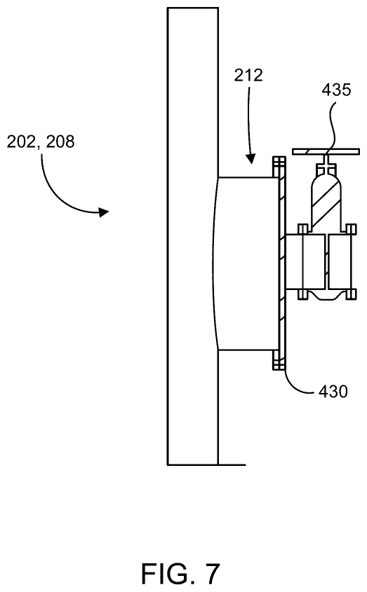

Turning to FIG. 4, a side view of a representative side manway 112 of a tank 102 filled with flammable fluid 108 is shown sealed by a lid 430. The side manway (e.g., manway 112) and/or lid 430 may have a diameter such as a 24″, 36″ etc. diameter. FIGS. 4-7 illustrate the process and/or method step 301 of attaching a gate valve 435 (e.g., a temporary gate valve 435) to lid 430 of the side manway (e.g., manway 112) via a hot tapping process. Specifically, as shown in FIG. 5, gate valve 435 is coupled to lid 430 of the side manway (e.g., manway 112) (e.g., via a weld). A hot tap assembly 440 (e.g., a bit, a sealed drilling chamber, a power source, a drilling machine, etc.) is coupled to the other end of gate valve 435. Gate valve 435 is then opened so that the sealed drilling chamber of hot tap assembly 440 has access to lid 430. As shown in FIG. 6, the drill bit advances forward through gate valve 435 and drills a hole (e.g., a 12″, 16″, 18″ diameter hole) is cut in the manway lid 430 exposing/filling the sealed drilling chamber to flammable fluid and pressurizing the sealed drilling chamber. The drill bit is retracted back into the sealed drilling chamber along with a coupon (e.g., the round cut-out taken from lid 430) and gate valve 435 is closed, as shown in FIG. 7. Also as shown in FIG. 7, after gate valve 435 is closed, hot tap assembly 440 can be de-pressurized, drained of drilling fluid, and removed from the now installed gate valve 435.

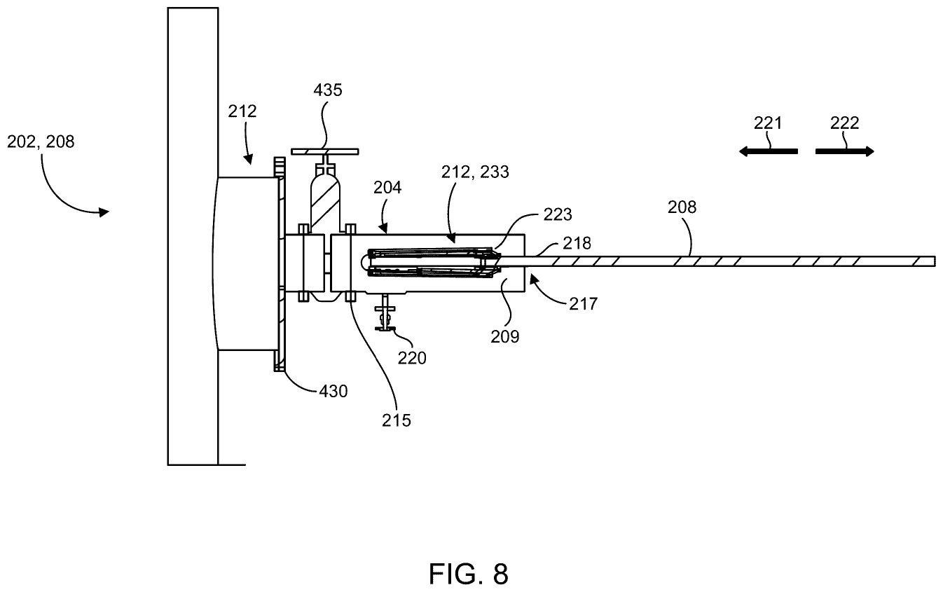

Turning to FIGS. 8-18, steps of method 300 are shown to seal a tank side manway and install a device thereto, according to an exemplary embodiment.

At step 304, method 300 may include providing a barrier 212 that is engageable with a rod 208 and moveable between an extended state 234 and a retracted state 233. This step may also include disposing barrier 212 within a housing 204 in retracted state 233. For example, as shown in FIGS. 2A and 8, barrier 212 may be sufficiently compact in retracted state 233 such that the entirety of barrier 212 may be placed inside chamber 209 of the housing. In some embodiments, barrier 212 may be inserted via aperture 214 of housing 204 while first end 223 of rod 208 is inserted via aperture 217 to engage with barrier 212 inside housing 204. In some examples, in the expanded state, actuator 216 can move one or more of actuating supports 244 between a first position relative to central shaft 240 and a second position closer to the first end of central shaft 240 to enable canopy 246 to expand outward and in a radial direction away from central shaft 240, whereas, in the retracted state (also referred to interchangeably as the “contracted state”), actuator 216 can move one or more of actuating supports 244 between a first position relative to central shaft 240 and a second position closer to the first end of central shaft 240 to enable canopy 246 to contact inward and in the radial direction toward central shaft 240.

At step 308, method 300 may include coupling housing 204 to a gate valve 435 (e.g., a temporary gate valve 435 coupled to the side manway (e.g., manway 112)) of tank 102 such that rod 208 extends out of housing 204 via a seal 218 (e.g., extends through and engages with aperture 217 via a sealed interface) and away from tank 102. As shown in FIG. 8, mounting features 215 of housing 204 may couple housing 204 to gate valve 435 such that chamber 209 is fluidly coupled (e.g., fluid-tight, air-tight) against gate valve 435.

At step 312, method 300 may include opening gate valve 435 to allow fluid to fill and pressurize housing 204 (e.g., chamber 209) around barrier 212 in retracted state 233. For example, gate valve 435 of FIG. 8 may be moved to the open position such that fluid inside the tank enters chamber 209. The interior of chamber 209, barrier 212, and the portion of rod 208 inside chamber 209 will be subject to the pressure of the fluid inside the tank at the depth of the side manway (e.g., manway 112), while exterior 211 of housing 204 and the portion of rod 208 outside the chamber may be subject to ambient (e.g., atmospheric) pressure. In some embodiments, chamber 209 may be pressurized prior to the opening of gate valve 435. For example, method 300 may include filling housing 204 with pressurized tank fluid or an inert gas via a pump, a purge valve/system, valve 220, or the like.

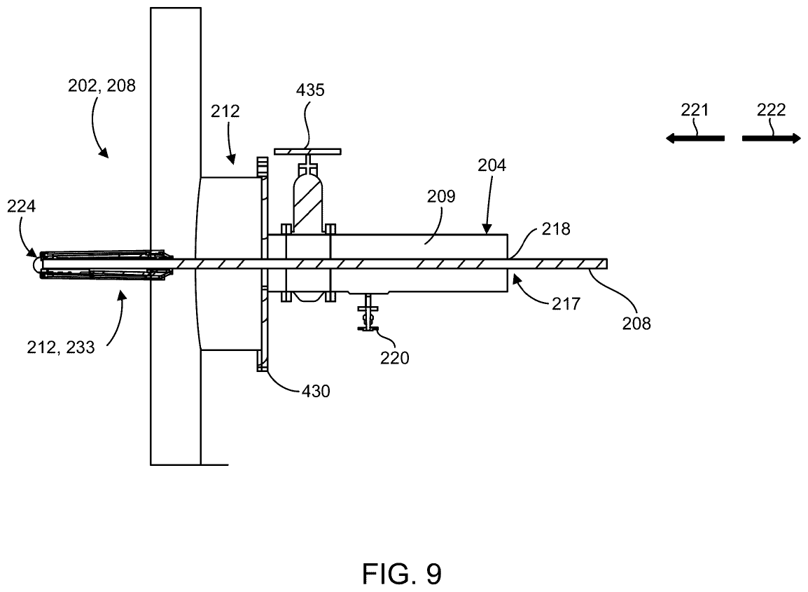

At step 316, method 300 may include inserting, via a first movement of rod 208, barrier 212 into tank 102 containing fluid by moving rod 208 toward tank 102 (e.g., in first direction 221. As shown in FIG. 9, rod 208 has been translated in first direction 221 such that barrier 212 is inserted inside tank 102. One or more sensors 224 may confirm and/or detect a distance that rod 208 and/or barrier 212 has travelled from housing 204 into tank 102 to ensure that barrier 212 is sufficiently clear of the walls of the side manway (e.g., manway 112). For example, a first distance value indicating that barrier 212 is within tank 102 can be received. In some cases, the first distance value can be received by controller 228 from a proximity sensor (e.g., of sensors 224) coupled to barrier 212.

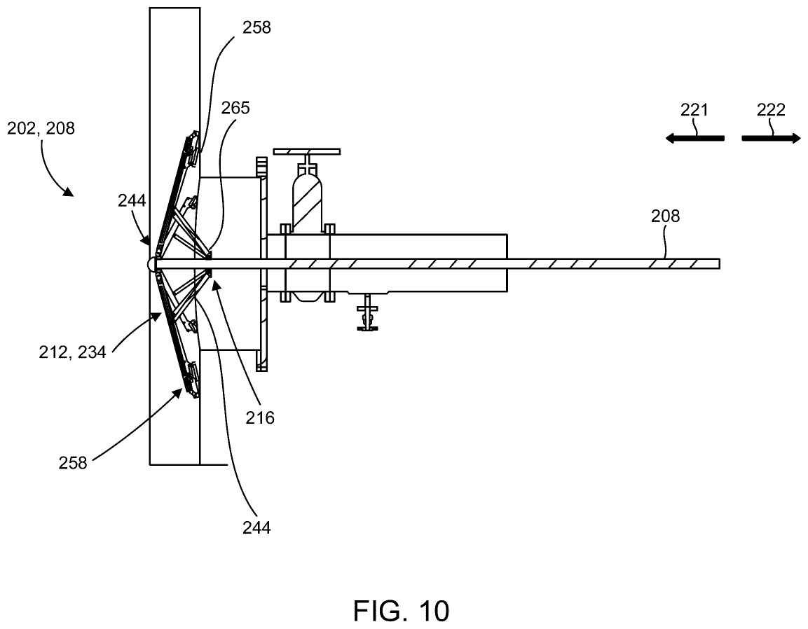

At step 320, method 300 may include moving, via an actuator 216, barrier 212 from retracted state 233 to extended state 234 while inside tank 102 and clear of the side manway (e.g., manway 112). As shown in FIG. 10, actuator 216 may be activated (e.g., by an operator, by controller 228, etc.) causing barrier 212 to expand. In the illustrated embodiment, actuator 216 moves a runner 265 connected to actuating supports 244 from first position 263 to second position 264 closer to first end 241 of central shaft 240 (Sec, e.g., FIG. 2C). As discussed above, actuator 216 may be activated in a variety of ways such as by rotating rod 208 to turn and apply pressure to a piston, applying hydraulic fluid to the actuator via rod 208, etc. Once barrier 212 has expanded inside tank 102, at step 324, method 300 may include engaging, via a second movement of rod 208 opposite the first movement (e.g., in second direction 222), barrier 212 and/or sealing surface 258 thereof with an inner wall of tank 102 around the side manway (e.g., manway 112). As shown in FIG. 10, barrier 212 in extended state 234 has been pulled back against the tank wall such that sealing surface 258 abuts the tank wall (e.g., continuously around the perimeter of barrier 212) and covers the side manway (e.g., manway 112). In some cases, a second distance value indicating that barrier 212 is engaging an inner wall of tank 102 around a side/area/region of manway 112, may be received. In some cases, the second distance value can be received by controller 228 from a proximity sensor (e.g., of sensors 224) coupled to barrier 212.

In some cases, the proximity sensor used to measure the first distance value is the same or similar to the proximity sensor used to measure the second distance value. Alternatively, separate and/or different proximity sensors can be used to measure the first distance value, the second distance value, and/or other distance values.

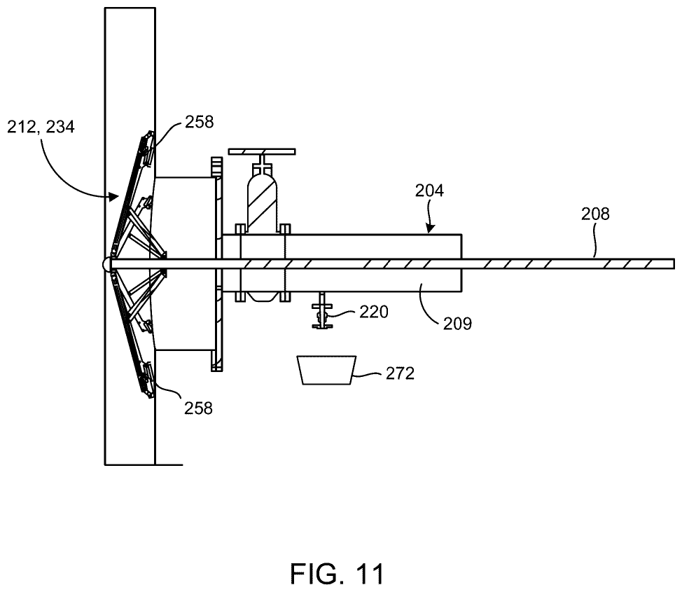

At step 328, method 300 may include depressurizing housing 204 to create a pressure differential across barrier 212, the pressure differential sealing barrier 212 against the inner wall of tank 102 around the side manway (e.g., manway 112). As shown in FIG. 11, depressurizing housing 204 may occur, after verifying sealing surface 258 has formed a seal around manway 112, by opening valve 220 and exposing chamber 209 to ambient pressure. Accordingly, as depicted in FIG. 11, a high pressure caused by the weight of the fluid in tank 102 will exist on the left side of barrier 212 (e.g., the fluid-facing side of canopy 246 directed towards the interior of tank 102) while a low pressure (atmospheric pressure) will exist on the right side of barrier 212 (e.g., the tank-facing side of barrier 212 directed to the exterior of the tank). The pressure differential will create a force pushing barrier 212 against the tank wall and forming a seal of manway 112 (e.g., blocking fluid from leaving tank 102 via manway 112). Additionally, depressurizing housing 204 may include draining the fluid within chamber 209 (e.g., into a collection tank 272, via a pump, etc.). As described herein, depressurizing housing 204 refers to reducing an internal pressure inside housing 204. In some examples, depressurizing can include reducing the internal pressure by at least a threshold amount of pressure.

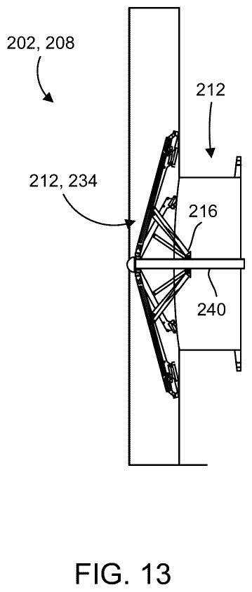

At step 332, method 300 may include removing rod 208, housing 204, and gate valve 435 from tank 102, as illustrated in FIGS. 12-13. For example, with barrier 212 held against the tank wall by the pressure differential, first end 223 of rod 208 may disengage from barrier 212, central shaft 240, and/or actuator 216. Barrier 212 will remain held in place by the force from the fluid in tank 102. Accordingly, rod 208 may be removed (e.g., translated in second direction 222 away from and out of tank 102). Similarly, as shown in FIG. 13, with barrier 212 acting as a seal of the side manway (e.g., manway 112), housing 204 and gate valve 435 may be removed from tank 102, leaving the side manway exposed and accessible while barrier 212 prevents fluid and/or vapors from escaping/leaving via the side manway (e.g., manway 112). In some cases, rod 208 can be removed from housing 204 responsive to controller 228 receiving an indication (e.g., a signal, data, etc.) of the pressure differential. For example, controller 228 can receive an indication of the pressure differential across barrier 212 based on a signal from a first pressure sensor (e.g., of sensors 224 measuring the first pressure and outputting the first pressure value representing the first pressure) and a signal from a second pressure sensor (e.g., of sensors 224 measuring the second pressure and outputting the second pressure value representing the second pressure).

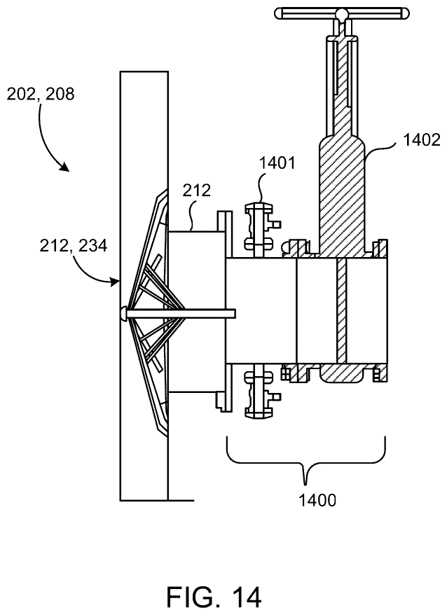

At step 336, method 300 may include installing a device 1400 (e.g., equipment) to the side manway (e.g., manway 112). For example, while barrier 212 blocks manway 112, the environment surrounding the outside of manway 112 is not exposed to zone 0 vapors as fluid cannot pass through barrier 212 (e.g., the flammable fluid is from the side shell manway 112 by the deployed barrier 212). Accordingly, one or more devices 1400 such as a manway adapter 1401, an isolation valve 1402, or other suitable equipment may be coupled to manway 112, as shown in FIG. 14.

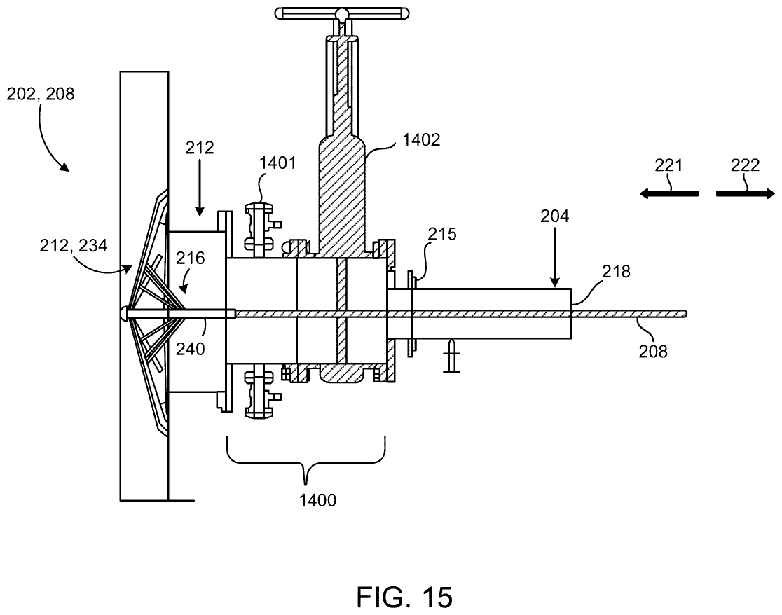

At step 340, method 300 may include coupling housing 204 to device 1400 such that rod 208 extends out of housing 204 via seal 218 and away from tank 102, as shown in FIG. 15. FIGS. 14-17 illustrate an example process/method step(s) of retrieving barrier 212 from tank 102 and completing the installation of device 1400. As shown in FIG. 15, housing 204 and rod 208 may be coupled to device 1400. Like in step 308, housing 204 may be fluidly coupled to device 1400 via mounting features 215. At step 344, method 300 may include engaging rod 208 with barrier 212. For example, in FIG. 15, rod 208 has been moved in first direction 221, through device 1400 and the side manway (e.g., manway 112) until first end 223 of rod 208 re-engages and/or couples to barrier 212, central shaft 240, and/or actuator 216.

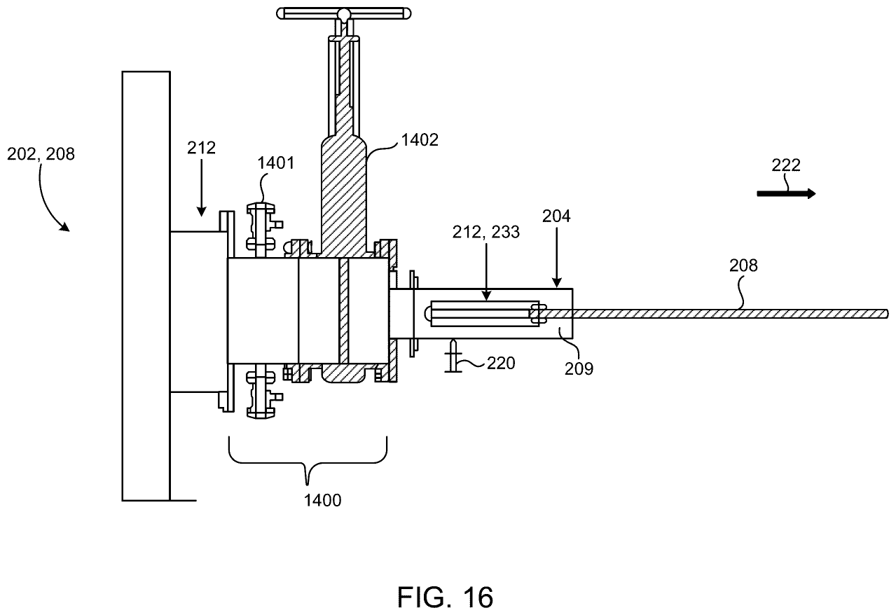

At step 348, method 300 may include moving, via actuator 216, barrier 212 from extended state 234 to retracted state 233 while inside tank 102 and clear of the side manway (e.g., manway 112). In some embodiments, method 300 may include pressurizing housing 204 (e.g., chamber 209, the interior of device 1400, etc.) prior to moving barrier 212 from extended state 234 to retracted state 233 (e.g., by filling housing 204 with a pressurized fluid, inert gas, or the like). Accordingly, barrier 212 may be moved in first direction 221 (via movement of rod 208). As shown in FIG. 16, actuator 216 is activated such that barrier 212 returns to retracted state 233. Upon moving toward retracted state 233 and/or in second direction 222, the seal formed by sealing surface 258 against the wall of tank 102 may be released and flammable fluid may flow into the side manway (e.g., manway 112), device 1400, and/or housing 204 (e.g., chamber 209) and may be contained therein.

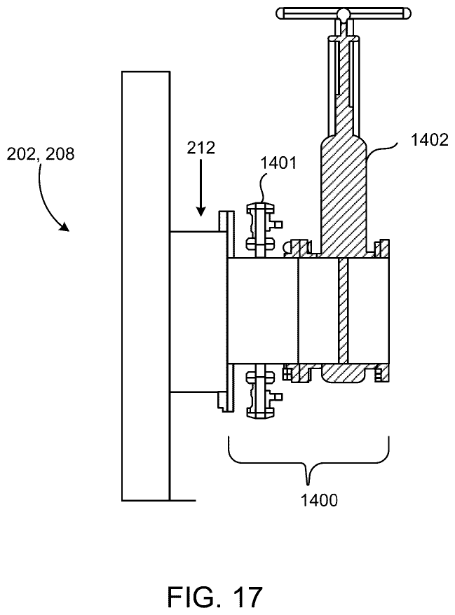

At step 352, method 300 may include moving, via a third movement of the rod opposite the first movement (e.g., in second direction 222), the barrier in the retracted state from the tank through the device and into the housing. As shown in FIG. 16, barrier 212 in retracted state 233 may fit back through the side manway (e.g., manway 112) and into housing 204, at which point (at step 356) a valve of the device (e.g., isolation valve 1402) may be closed, scaling/separating housing 204 from the interior of tank 102 and the flammable fluid therein. Housing 204 may again be de-pressurized and drained (e.g., via valve 220), and, at step 360, System 200, housing 204, and the components thereof may be removed from device 1400 and separated from the tank as shown in FIG. 17, leaving device 1400 installed to the side manway (e.g., manway 112) without requiring the fluid level of tank 102 to be drained below the level of the side manway (e.g., manway 112).

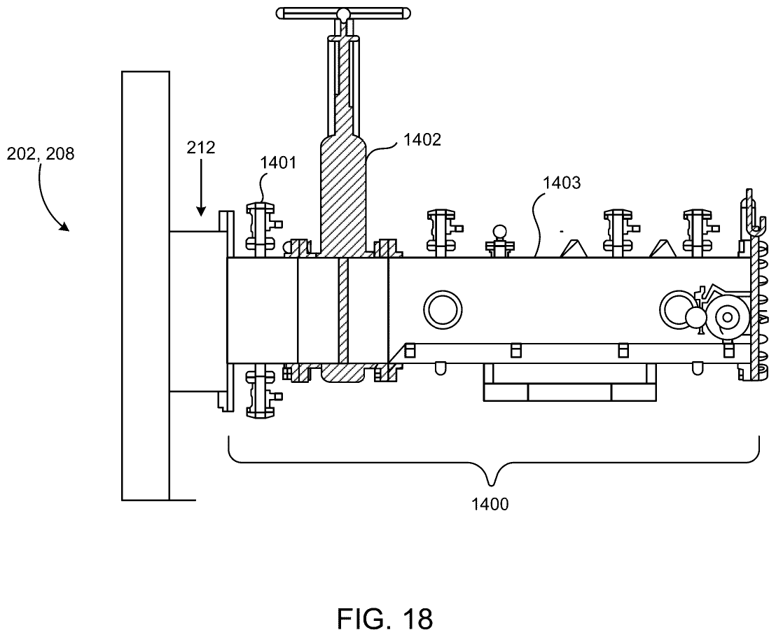

As shown in FIG. 18, once device 1400 such as the manway adapter (e.g., adapter 1401) and isolation valve 1402 are installed, a side launcher 1403 for an inspection vehicle can then be coupled to the side manway (e.g., manway 112) such that tank inspection can occur. In this way, the systems, methods, and apparatuses for sealing a side shell manway can augment the process of tank inspection by avoiding the need to drain tank 102 before installing the side launcher and/or isolation valve and inspecting the tank. Adapter 1401 can be configured to couple to side launcher 1403 for the inspection vehicle. In some examples, adapter 1401 can be coupled to side launcher 1403 using a variety of coupling mechanisms. For example, the coupling can be mechanical/structural couplings (e.g., physical coupling, welds, temporary couplings, etc.) and/or communicative (e.g., wired or wireless connections), or any combination thereof.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. A system to couple a device to a side manway of a tank comprising a fluid, the system comprising:
a housing comprising:
a first end and a second end, the first end configured to couple to a gate valve and the second end having an aperture; and
a chamber defined between the first end and the second end and extending along a longitudinal axis;
a rod disposed within the aperture to create a seal between the chamber and an exterior of the housing, the rod configured to move along the longitudinal axis in either a first direction toward the first end of the housing or in a second direction toward the second end of the housing;
a barrier configured to move between an expanded state and a retracted state, the barrier configured to be disposed inside the housing in the retracted state and comprising:
a central shaft having a first end and a second end, the second end configured to engage with the rod;
a canopy having a central edge coupled to the first end of the central shaft and extending radially from the central shaft to an outer edge of the canopy;
a support rib extending radially along the canopy; and
an actuating support having a first end and a second end, the first end coupled to the support rib and the second end slidably coupled to the central shaft; and
an actuator configured to move the second end of the actuating support between a first position relative to the central shaft and a second position closer to the first end of the central shaft so as to expand the canopy outward and in a radial direction away from the central shaft to the expanded state or contract the canopy inward and in the radial direction toward the central shaft to the retracted state.

2. The system of claim 1, wherein:
the actuator comprises a runner that is moveable toward the first end of the central shaft and the second end of the central shaft in response to a rotation of the rod while the rod is engaged with the central shaft;
the rotation of the rod in a first direction, while engaged with the central shaft, moves the second end of the support rib toward the second position relative to the central shaft and thereby moves the canopy toward the expanded state; and
the rotation of the rod in a second direction opposite the first direction, while engaged with the central shaft, moves the second end of the support rib toward the first position relative to the central shaft and thereby moves the canopy toward the retracted state.

3. The system of claim 1, wherein the central shaft further comprises:
a hub disposed within the central shaft and having an open state and a closed state, the hub configured to secure the support rib in the second position and the canopy in the expanded state, wherein the rod is configured to toggle the hub between the open state or the closed state.

4. The system of claim 1, wherein the actuator comprises a piston configured to receive pressurized hydraulic fluid.

5. The system of claim 1, wherein the canopy further comprises:
a fluid-facing surface configured to face toward an interior of the tank when in the expanded state inside the tank and a tank-facing surface, opposite the fluid-facing surface, configured to face toward the exterior of the tank when in the expanded state inside the tank; and
a sealing surface coupled to the tank-facing surface of the canopy proximate to the outer edge of the canopy, the sealing surface configured to engage a wall of the tank around the side manway to form a fluid-tight seal.

6. The system of claim 5, further comprising:
a first pressure sensor coupled to the system on a fluid-facing side of the canopy and configured to detect a first pressure; and
a second pressure sensor coupled to the system on a tank-facing side of the canopy and configured to detect a second pressure.

7. The system of claim 5, wherein the sealing surface extends continuously around a perimeter of the outer edge of the canopy.

8. The system of claim 1, wherein the housing further comprises:
a valve configured to seal or unseal the chamber, wherein the valve is configured to create a pressure differential across the canopy to secure the canopy in the expanded state against the tank in response to an unsealing of the chamber while the canopy is in the expanded state inside the tank.

9. A method to couple a device to a side manway of a tank comprising a fluid, the method comprising:
providing a barrier that is engageable with a rod and moveable between an expanded state and a retracted state;
disposing the barrier within a housing in the retracted state;
coupling the housing to a gate valve of the tank such that the rod extends out of the housing via a seal and away from the tank;
opening the gate valve to allow fluid to fill and pressurize the housing around the barrier in the retracted state;
inserting, via a first movement of the rod, the barrier into the tank by moving the rod towards the tank;
moving, via an actuator, the barrier from the retracted state to the expanded state while inside the tank and clear of the side manway;
engaging, via a second movement of the rod opposite the first movement, the barrier with an inner wall of the tank around the side manway;
depressurizing the housing to create a pressure differential across the barrier, the pressure differential sealing the barrier against the inner wall of the tank around the side manway;
removing the rod, the housing, and the gate valve of the tank; and
installing the device to the side manway.

10. The method of claim 9, wherein depressurizing the housing to create the pressure differential across the barrier comprises opening a valve of the housing to expose an interior of the housing to ambient conditions.

11. The method of claim 9, further comprising:
coupling the housing to the device such that the rod extends out of the housing via the seal and away from the tank;
engaging the rod with the barrier;
moving, via the actuator, the barrier from the expanded state to the retracted state while inside the tank and clear of the side manway;
moving, via a third movement of the rod opposite the first movement, the barrier in the retracted state from the tank through the device and into the housing;
closing a valve of the device; and
removing the rod, the housing, and the barrier from the device.

12. The method of claim 11, further comprising:
pressurizing the housing prior to moving the barrier from the expanded state to the retracted state.

13. The method of claim 12, wherein pressurizing the housing prior to moving the barrier from the expanded state to the retracted state comprises filling the housing with a pressurized tank fluid or an inert gas.

14. The method of claim 11, wherein the device comprises an adapter configured to couple to a side launcher for an inspection vehicle and wherein the method further comprises:
coupling the side launcher to the adapter.

15. A method to couple a device to a side manway of a tank comprising a fluid, the method comprising:
providing a barrier that is engageable with a rod, moveable between an expanded state and a retracted state, and disposed within a housing in the retracted state;
providing a controller communicatively connected to a sensor and an actuator associated with the barrier;
coupling the housing to a gate valve of the tank such that the rod extends out of the housing via a seal and away from the tank;
receiving, by the controller, a first pressure value above a pressure threshold;
responsive to receiving the first pressure value, inserting the barrier into the tank by moving the rod towards the tank;
receiving, by the controller, a first distance value indicating that the barrier is within the tank;
responsive to receiving the first distance value, sending a first signal by the controller to the actuator to move the barrier from the retracted state to the expanded state;
receiving, by the controller, a second distance value indicating that the barrier is engaging an inner wall of the tank around the side manway;
responsive to receiving the second distance value, opening a valve of the housing;
receiving, by the controller, an indication of a pressure differential across the barrier above a pressure differential threshold;
responsive to receiving the indication of the pressure differential above the pressure threshold, removing the rod, the housing, and the gate valve of the tank; and
installing the device to the side manway.

16. The method of claim 15, wherein the controller receives the first pressure value via a pressure sensor within the housing.

17. The method of claim 15, wherein the controller receives the first distance value and the second distance value via a proximity sensor coupled to the barrier.

18. The method of claim 15, wherein the controller receives the indication of the pressure differential across the barrier based on a signal from a first pressure sensor on a fluid-facing side of the barrier and a signal from a second pressure sensor on a tank facing side of the barrier.

19. The method of claim 15, further comprising:
coupling the housing to the device such that the rod extends out of the housing via the seal and away from the tank;
engaging the rod with the barrier;
pressurizing the housing until the controller detects at least one of:
a third pressure within the housing above a second pressure threshold, or
a second pressure differential across the barrier below a second pressure differential threshold;
responsive to receiving at least one of the third pressure within the housing above the second pressure threshold or the second pressure differential across the barrier below the second pressure differential threshold, sending a second signal by the controller to the actuator to move the barrier from the expanded state to the retracted state;
receiving, by the controller, a third distance value indicating that the barrier is within the housing;
responsive to receiving the third distance value, closing a valve of the device; and
removing the rod, the housing, and the barrier from the device.

20. The method of claim 15, wherein the actuator is a piston configured to receive a hydraulic fluid and the controller is configured to vary a pressure of the hydraulic fluid within the piston.
